(19) United States
(12) Patent Application Publication
(10) Pub. No.: US 2016/0253735 A1
(43) Pub. Date: Sep. 1, 2016

(54) Closed-Loop Dynamic Content Display System Utilizing Shopper Proximity and Shopper Context Generated in Response to Wireless Data Triggers

(71) Applicant: Shelfscreen, LLC, Wayne, NJ (US)

(72) Inventors: Jeff Scudillo, Wayne, NJ (US); Alex Kalpaxis, Ridgefield, NJ (US); Marc Scudillo, Millstone, NJ (US); Michael Monaco, Long Valley, NJ (US)

(73) Assignee: Shelfscreen, LLC, Wayne, NJ (US)

(21) Appl. No.: 14/980,203

(22) Filed: Dec. 28, 2015

Related U.S. Application Data
(60) Provisional application No. 62/097,980, filed on Dec. 30, 2014.

(51) Int. Cl. G06Q 30/06; G06Q 30/02

(52) U.S. Cl. CPC G06Q 30/0631; G06Q 30/0623; G06Q 30/0261; G06Q 30/0269

(57) ABSTRACT

The smart retail system described herein presents information to shoppers based on the shopper's actions and state. In one embodiment, information, such as advertisements, are presented to a shopper when the system detects a shopper near a display of the system. In one embodiment, a shopper detected to be moving toward a particular location with respect to a display of the system can be presented with information designed to catch the shopper's eye and direct the shopper's attention to a particular item or product. The information displayed to the shopper can be changed based on the shopper's actions such as stopping to analyze the item or product to which the information pertains. Information can also be pushed to a shopper's mobile device in response to the shopper's actions and state. For example, a coupon for a particular product can be transmitted (also referred to as pushed) to the shopper's mobile device as the shopper is examining the particular product or when the shopper has been detected walking away from the particular product.

This application claims priority to U.S. Provisional Application No. 62/097,980 filed on Dec. 30, 2014, the disclosure of which is herein incorporated by reference in its entirety.

### BACKGROUND

Manufacturers and stores use advertising to entice shoppers to purchase their products. These entities may use print, broadcast (e.g., television or radio), internet, etc. to present advertisements to people. These entities are also continually looking for new ways to connect with shoppers so that they purchase the advertised products.

### SUMMARY

The present disclosure relates generally to intelligent displays, and more particularly to closed-loop retail displays for displaying information based on a shopper's actions and state in response to wireless data triggers. In an embodiment, a method includes outputting first content via an output device. The first content pertains to an item for sale located in an area associated with the output device. A person located in the area is detected and the state of the person is determined. An action the person is performing is also determined. A context of the person is determined based on the state of the person and the action the person is performing. Second content is output via the output device. The second content pertains to the item for sale and is selected based on the context of the person.

In an embodiment, the determining the state of the person includes identifying the person and determining a biometric of the person. The detecting the person can include transmitting a signal from a device associated with the output device and receiving, by the device, a message from a user device associated with the person. The message from the user device can be transmitted in response to the user device receiving the signal. The first content can be configured to draw the gaze of the person. In an embodiment, the determining the state of the person includes receiving data associated with the person from a plurality of sensors. The determining the action of the person is performing can include detecting that the gaze of the person is directed to the output device or the item for sale. In an embodiment, the determining the action the person is performing includes detecting that the person is examining the item. Third content is output in response to detecting that the person is examining the item. The examining the item can be that the person looking at the item and the third content can pertain to the item. The third content can be selected based on the person looking at the item. The examining the item can also be that the person has picked up the item. A message can be transmitted to the user device in response to determining that the person is examining the item. The action that the person is performing can include determining that the person is dwelling or that the person is moving through the area. In an embodiment, the output device can be attached to a retail shelf storing at least one item.

### BRIEF DESCRIPTION OF THE DRAWINGS

FIG. 1 depicts a smart retail display (SRD) system according to one embodiment;

FIG. 2 depicts a smart retail display comprising a number of shelf screens located on shelves of a gondola according to one embodiment;

FIG. 3A depicts components of a shelf screen according to one embodiment;

FIG. 3B depicts shelf screen components mounted to a gondola according to one embodiment;

FIG. 3C depicts a smart mat of a shelf screen according to one embodiment;

FIG. 4 depicts an SRD cluster controller according to one embodiment;

FIG. 5 depicts a flow chart of a method for displaying information to a shopper according to one embodiment;

FIG. 6 depicts details of one of the steps of the method of FIG. 5 according to one embodiment;

FIG. 7 is a high-level block diagram of a computer that may be used to implement the components of the system of FIG. 1;

FIG. 8 depicts a schematic of a Smart Retail Display cluster control system according to one embodiment;

FIG. 9 depicts a schematic of an Smart Retail Display cluster control controller according to one embodiment;

FIG. 10 depicts a schematic of a wireless CDMA/LTE cellular network interface according to one embodiment;

FIG. 11 depicts a schematic of a wireless network interface according to one embodiment;

FIG. 12 depicts a schematic of an antenna front end for a Smart Retail Display cluster controller according to one embodiment;

FIG. 13 depicts a schematic of an acoustic sensing subsystem of a Smart Retail Display cluster controller according to one embodiment;

FIG. 14 depicts a schematic of a power subsystem of a Smart Retail Display cluster controller according to one embodiment;

FIG. 15 depicts a message transmission diagram according to one embodiment;

FIG. 16 depicts a binary search tree which can be used in a decision tree (binary tree) context-aware data algorithm according to one embodiment.

### DETAILED DESCRIPTION

The smart retail system described herein presents information to shoppers based on the shopper's actions and state. In one embodiment, information, such as advertisements, are presented to a shopper when the system detects a shopper near a display of the system. In one embodiment, a shopper detected to be moving toward a particular location with respect to a display of the system can be presented with information designed to catch the shopper's eye and direct the shopper's attention to a particular item or product. The information displayed to the shopper can be changed based on the shopper's actions such as stopping to analyze the item or product to which the information pertains. Information can also be pushed to a shopper's mobile device in response to the shopper's actions and state. For example, a coupon for a particular product can be transmitted (also referred to as pushed) to the shopper's mobile device as the shopper is examining the particular product or when the shopper has been detected walking away from the particular product.

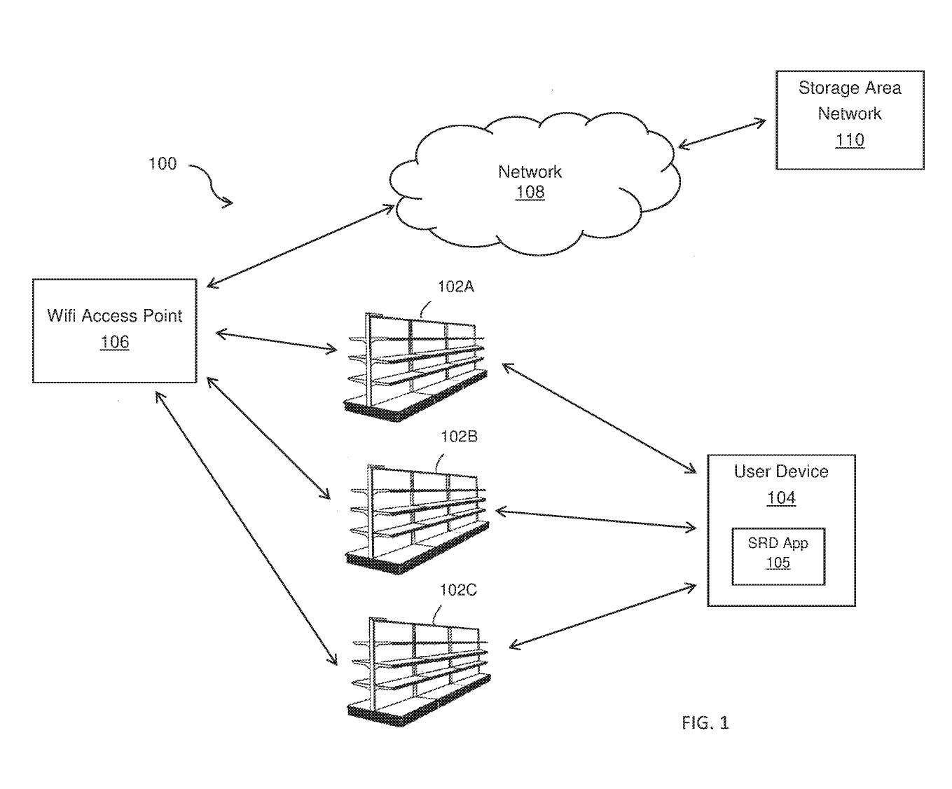

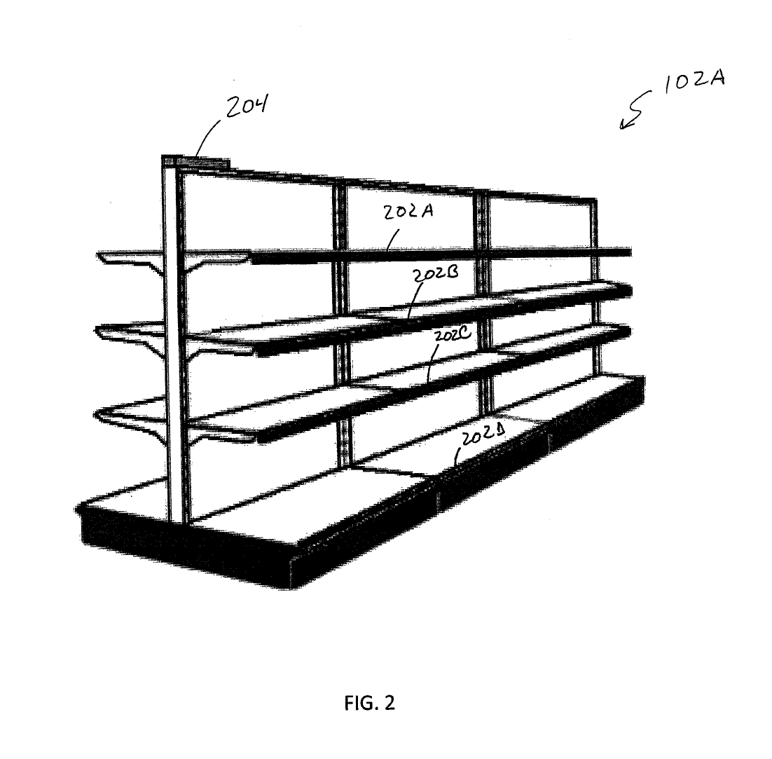

FIG. 1 depicts system 100 for a smart retail display (also referred to as SRD system 100) according to one embodiment. SRD system 100 displays information to a consumer via one or more displays based on the shopper's actions and state (e.g., emotional state and/or biological state based on one or more biological metrics such as heartrate, etc.).

Multiple smart retail displays (SRD) 102A,102B,102C are capable of displaying information to consumers and communicating with user device 104, which in one embodiment, is carried by a user while shopping. User device 104, in one embodiment, is a smart phone, but can be any type of device carried by a user and capable of communicating with SRDs 102A,102B,102C. In one embodiment, SRDs 102A,102B,102C communicate with user device 104 wirelessly via a Bluetooth Low Energy (BLE) communication channel but can communicate via other wireless communication channels and methods such as Wi-Fi. Information (e.g., advertisements and/or coupons) can be transmitted to user device 104 from one of smart retail displays 102A, 102B, 102C or via other methods described in detail below. In one embodiment, SRD system 100 can store and provide store product availability, predetermined shopping list routes, and shopping lists to a shopper via the shopper's user device. Each SRD 102A,102B,102C can communicate with one another directly or via Wi-Fi access point 106. In addition, smart retail displays 102A,102B,102C can communicate with storage area network 110 via network 108. Storage area network 110 can receive, interpret, and store information, such as shopper actions (e.g., how the consumer moved through a store, what the consumer purchased, etc.) received from smart retail displays 102A,102B,102C.

Wi-Fi access points of SRD system 100 can be used to track mobile devices as they are carried by shoppers through a location such as a store. The signal strength and location of Wi-Fi access points (such as Wi-Fi access point 106 of FIG. 1) can be determined and this information can be used to determine the location of one or more mobile devices (such as user device 104 of FIG. 1). Signal fingerprints (e.g. unique identifiers of mobile devices) received from mobile devices can be used to track the location of a particular mobile device. For example, the location of a particular mobile device at a particular time can be determined and then associated with the particular mobile device's signal fingerprint. By periodically determining the location of a particular mobile device, changes in the location of the particular mobile device can be determined. In addition, shoppers' paths through a particular location (such as a retail store) can be tracked and this information can be stored for later analysis. Shoppers' paths through the store can be used to predict later shopper's paths and determine information to be displayed to a particular shopper based on previous shoppers' paths.

FIG. 2 depicts smart retail display 102A comprising multiple shelf screens 202A,202B,202C,202D which, in one embodiment, each comprise an elongated display for presenting information to consumers. Each shelf screen 202A,202B,202C,202D is mounted to a respective shelf of a gondola and can communicate with smart retail display cluster controller (SRDCC) 204. In one embodiment, each shelf screen 202A,202B,202C,202D can communicate wirelessly with SRDCC 204 via BLE but can also communicate via other wireless methods such as Wi-Fi, etc. SRDCC 204 can communicate wirelessly with Wi-Fi access point 106, user device 104, and storage area network 110 (via network 108) as shown in FIG. 1. In one embodiment, SRDCC 204 communicates with user device 104 wirelessly via BLE but can communicate with user device 104 via other methods such as Wi-Fi or cellular. In one embodiment, SRDCC 204 communicates with storage area network 110 via network 108 wirelessly using cellular methods but can also communicate with storage area network 110 via other methods. For example, in one embodiment, SRDCC 204 can communicate with storage area network 110 wirelessly via Wi-Fi access point 106 and a packet based network such as the Internet. In one embodiment, SRDCC 204 communicates directly with storage area network 110 via wireless methods such as cellular or Wi-Fi.

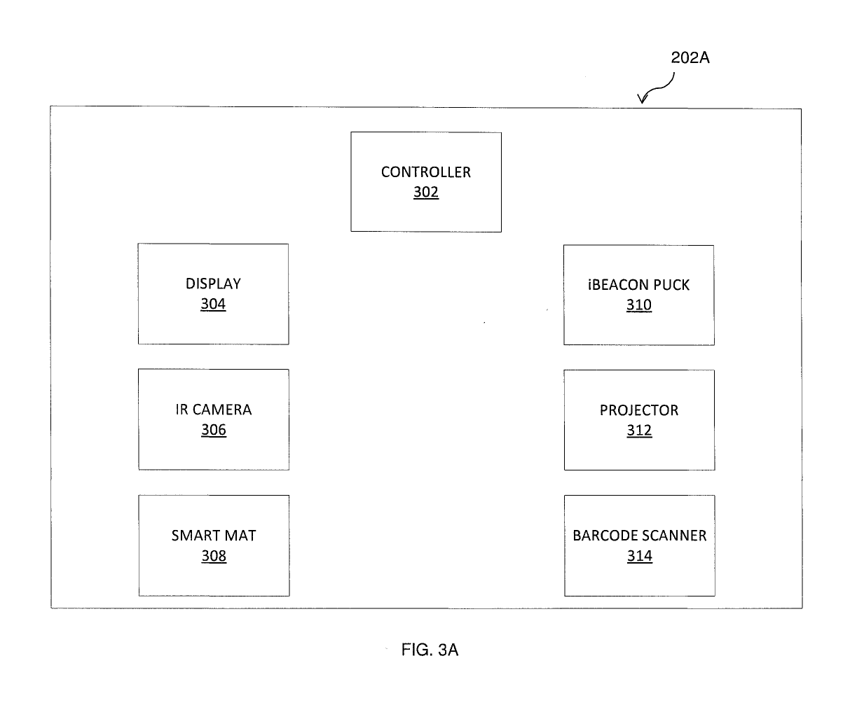

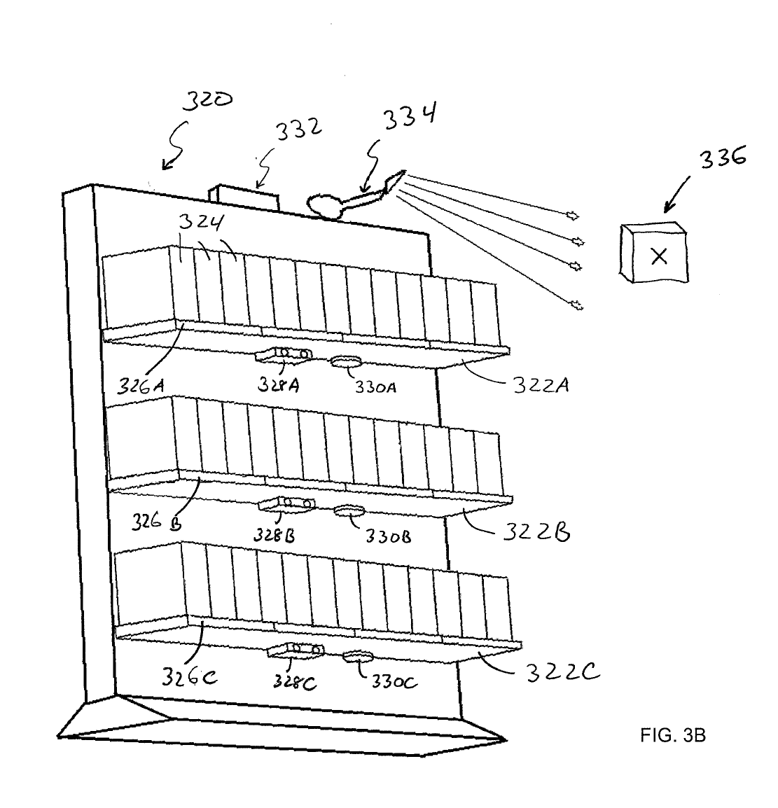

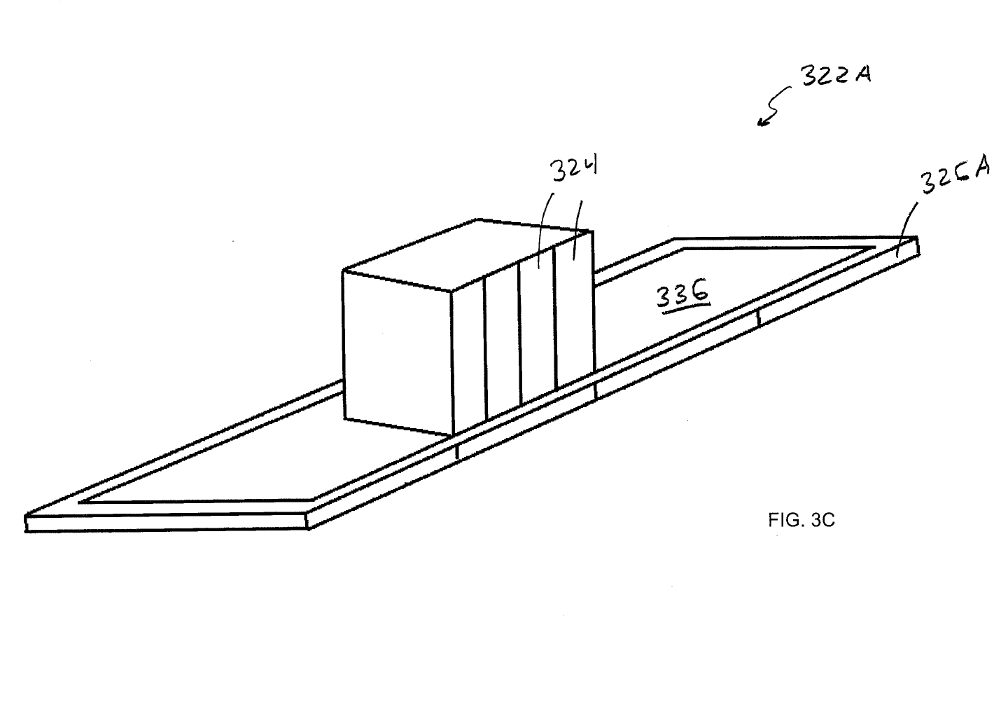

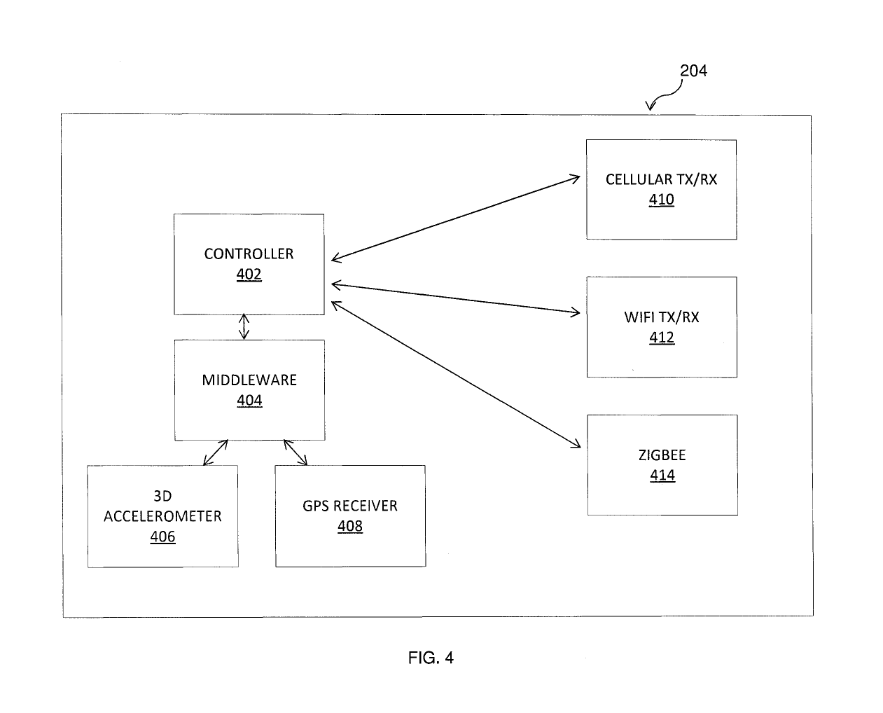

FIG. 3A depicts a block schematic diagram of shelf screen 202A which, in one embodiment, comprises controller 302, display 304, infrared camera 306, smart mat 308, iBeacon puck 310, projector 312, and barcode scanner 314. Shelf screens 202B,202C,202D are similarly constructed. Controller 302 is in communication with each of display 304, infrared camera 206, smart mat 308, iBeacon puck 310, projector 312, and barcode scanner 314 and controls operation of shelf screen 202A.

Display 304, in one embodiment, is a screen that is approximately four feet long and one inch high and is used to present information to a consumer. In one embodiment, display 304 is configured to be placed on a shelf edge of a gondola. The gondola is configured to hold a variety of items for sale in a location such as a retail establishment. Display 304 can be frameless and display a continuous image along its entire length with no visible breaks in the image. The information presented on display 304 can vary along the width of the display 304. For example, the length of display 304 used to display information pertaining to a particular item can be based on how much space the particular item occupies along the length of the shelf on which display 304 is located. In one embodiment, display 304 is flexible and can be physically cut to lengths less than its entire 4 foot length. In one embodiment, display 304 can be physically cut at approximately 1 inch intervals during installation to fit the length of a particular shelf on which display 304 will be located. In one embodiment, display 304 is a highly durable and flexible OLED material that can be bent to fit multiple shelving systems and can also withstand periodic collisions with shopping carts and consumers.

Infrared (IR) camera 306, in one embodiment, is a camera for capturing images of people near shelf screen 202A and is in communication with controller 302. Infrared camera 306, in one embodiment, is capable of capturing images of a person near shelf screen 202A with sufficient resolution to determine facial expressions, body movement, limb movement, etc. Images from infrared camera 306 can be used to determine what a person located near shelf screen 202A is doing. For example, images captured via infrared camera 206 can be used to determine if the person is picking up and examining an item, a change in the person's facial expression while they are examining the item, etc. In one embodiment, an ultrasonic transmitter/receiver may be used instead of or in conjunction with IR camera 206.

Smart mat 308, in one embodiment, comprises a pressure sensitive mat that can be used to determine what items are on a shelf. In one embodiment, smart mat 308 is attached to a respective display 304 and extends rearward over a shelf surface on which display 304 is mounted. In operation, smart mat 308 is placed on a shelf and products and items are placed on smart mat 308. Smart mat 308 can be a grid of pressure transducers that output data to controller 302. The items currently on a shelf can be determined based on the data from smart mat 308. For example, if a weight and foot print of a particular item is known, data output from smart mat 308 can be used to determine if that particular item is on the shelf. Similarly, a number of the particular items can be determined to be on the shelf based on the number of footprints and weights detected (e.g., one layer of items on a shelf) and multiples of a particular item's weight on a single footprint (e.g., a particular item stacked on the shelf.)

iBeacon puck 310, in one embodiment, includes a Bluetooth Low Energy (BLE) module and a ZigBee communication module. In one embodiment, iBeacon puck 310 is configured to periodically or continuously transmit a beacon signal via BLE methods that can be received by a user's mobile device (e.g., a user's smart phone). iBeacon puck 310 also receives data from the user's mobile device via BLE methods in response to the user's mobile device detecting the beacon. In one embodiment, this interaction between iBeacon puck 310 and the user's mobile device is used to initiate a display of information to the user associated with the mobile device.

In one embodiment, iBeacon puck 310 includes an RF transceiver which incorporates a programmable output power mode using 0 dBm for nominal output power and has a programmable power range of −27 dBm to +4 dBm. The RF transceiver's receiver section has more than −91 dBm receive sensitivity at 1% PER, 20-byte packet. The RF transceiver has an integrated transmit/receive (T/R) switch for operation with the internal PA and LNA. The internal T/R switch uses a single balun to interface to a single-ended antenna. The following shows the RF interface pins and the associated analog blocks. There are separate PA blocks are associated with RFIN_x and PAO_x signal pairs. The RF interface allows both single port differential operation and dual port differential operation.

The SRD system implementation of beacons (referred to as iBeacons) uses a protocol to exchange RF transceiver power/energy level indicator content, which content directly correlates to that of the packets that are received, power/energy level. The power/energy level indicator is a relative signal strength indication (RSSI) measure which behaves as far-field signal strength reference. The SRD system's local and remote node RF transceivers exchange these RSSI measures on every remote/local node packet transaction sequence and by using exponential smoothing functions for filtering and thus making remote node location/proximity possible. This RSSI exponentially smoothed time-series data is further analyzed by differentiating with respect to time in order to determine the directional variation in spatial orientation of the remote node as it relates to the paired local node.

The RSSI filtering and analysis algorithm produces three key results, real-time remote to local node (iBeacon) linear distance separation, real-time rate of change in linear distance and real-time direction information as it relates to convergence or divergence of the distance between the remote and local node. RSSI power/energy is measured over a 64 microsecond period after the packet preamble and stored in RAM. This is performed by a clear channel assessment process which the base-band energy integrated over a specific time interval.

In one embodiment, a Microcontroller (also referred to as micro processor) Unit (MCU) controls the iBeacon's BLE transceiver, checks the status, and reads/writes data to the RF transceiver through a 4-wire Serial Peripheral Interface (SPI) port. The RF transceiver operates as a SPI slave device with the MCU as a master. A transaction between the MCU and the iBeacon's BLE transceiver occurs as multiple 8-bit bursts on the SPI. The SPI signal Chip Enable (CE) allows for a transaction on the SPI port to be framed by the active low CE input signal. A transaction is a minimum of 3 SPI bursts and can extend to a greater number of bursts.

An SPI Clock (SPICLK) is driven by the MCU to clock the iBeacon's BLE transceiver. Data is clocked into the MCU master or the iBeacon's BLE transceiver slave on the leading (rising) edge of the return-to-zero SPICLK and data out changes state on the trailing (falling) edge of SPICLK. Incoming data from the MCU is presented on the Master Out Slave In (MOSI) input. The iBeacon's BLE transceiver presents data to the MCU master on the Master In Slave Out (MISO) output.

An SPI port on the MCU transfers data in bursts of 8 bits, the RF transceiver requires that a complete SPI transaction be framed by CE, which requires three or more bursts per transaction. The assertion of CE to low signals the start of a transaction. The first SPI burst is a write of an 8-bit header to the iBeacon's BLE transceiver (MOSI is valid) that defines a 6-bit address of the internal resource being accessed and identifies the access as being a read or write operation.

A write is data written to the iBeacon's BLE transceiver and a read is data written to the SPI MCU master. The following SPI bursts will be either the write data (MOSI is valid) to the iBeacon's BLE transceiver or read data from the transceiver (MISO is valid). The SPI bus is capable of sending data simultaneously between MCU master and iBeacon's BLE transceiver slave. The number of data bytes (payload) is a minimum of 2 bytes and is extend to a larger number depending on the type of access. The number of payload bytes sent will always be an even integer. After the final SPI burst, CE is negated to high to signal the end of the transaction.

The implementation of the iBeacon technology which is based on BLE, in one embodiment, is an iBeacon puck (e.g., iBeacon puck 310 of FIG. 3) which is located on every shelf that has a SRD display (such as SS 202A of FIG. 2). The SRD iBeacon puck is managed via the ZigBee End Node interface by the SRD Cluster Controller using the SRD Middleware messaging interface. The iBeacons are broadcast by iBeacon puck 310.

Projector 312, in one embodiment, is a device for projecting a two-dimensional image on a surface. Projector 312 can be used to present information to a person nearby projector 312. The information displayed using projector 312 can augment information displayed on display 304 or be different information. In one embodiment, projector 312 can project three dimensional images (e.g., holograms) for display to a person near shelf screen 202A. In some embodiments, an image from a first projector of a first shelf screen may be used to augment information displayed on a second shelf screen and vice versa.

Barcode scanner 314, in one embodiment, is a scanner for detecting barcodes on items. Barcode scanner 314 can detect barcodes on items located on a shelf on which the shelf screen associated with barcode scanner 314 is located. In addition, a bar code of an item a user is currently handling (e.g., has removed from the shelf and is examining) can be detected by barcode scanner 314. In one embodiment, information from barcode scanner 314 can be used to identify particular items. In some embodiments, bar code information obtained via barcode scanner 314 can be used in conjunction with other components of shelf screen (e.g., shelf screen 202A) in order to determine an item a person is interested in (e.g., an item the person is looking at or handling). Use of barcode scanner 314 in conjunction with other components of shelf screens (e.g., shelf screens 202A, 202B, etc.) barcodes can be scanned from any angle. Scanning barcodes from any angle is referred to as “3600 Smart Scanning”.

FIG. 3B depicts components of a shelf screen (e.g., shelf screen 202A of FIG. 3A) mounted to a gondola according to one embodiment. It should be noted that in the embodiment depicted in FIG. 3B, only one of certain components, such as projector 328, may be used per gondola. Gondola 320 comprises multiple shelves 322A,322B,322C each of which is configured to support and display items 324 (e.g., products or items for sale). Each of multiple shelves 322A,322B,322C has a respective display 324A,324B,324C. Each of shelves 322A,322B,322C has a respective IR camera, barcode scanner, and controller, shown in FIG. 3 located in a common housing 328A,328B,328C. Each of shelves 322A,322B,322C has a respective iBeacon puck 330A,330B,330C. Gondola 320 has an SRDCC shown mounted on the top of gondola 320. Projector 334 is also shown mounted on top of gondola 320 and projecting image 336.

FIG. 3C depicts shelf 326A and display 326A of FIG. 3B and oriented to show a top surface of shelf 326A. FIG. 3C depicts multiple items 324 located on smart mat 336 which is positioned over the top surface of shelf 326A. In the embodiment shown in FIGS. 3B and 3C, the various components depicted communicate wirelessly with one another. In other embodiments, the various components may be wired to one another in various configurations.

FIG. 4 depicts SRD cluster controller (SRDCC) 204 comprising a controller in communication with cellular transmitter/receiver 410, Wi-Fi transmitter/receiver 412, and ZigBee transmitter/receiver 414. SRDCC 204 can communicate with various devices via cellular transmitter/receiver 410, Wi-Fi transmitter/receiver 412, and ZigBee transmitter/receiver 414. Controller 402 is also in communication with three-dimensional (3D) accelerometer 406 and global positioning system (GPS) receiver 408 via middleware 404. In one embodiment, 3D accelerometer 406 is used to detect movement of the gondola on which SRDCC 404 is located. In one embodiment, detection of movement of SRDCC 404 via 3D accelerometer 406 can be used to determine environmental conditions at the location in which SRDCC 204 is located. For example, sudden rapid movement detected by one or more SRDCCs can be interpreted to mean that an earthquake is occurring where the SRDCCs are located. In another embodiment, GPS receiver 408 and 3D accelerometer 406 can be used to determine a location of one or more SRDCCs. Controller 402 communicates with 3D accelerometer 406 and GPS receiver 408 via middleware 404 which, in one embodiment, is used to convert data received from 3D accelerometer 406 and GPS receiver 408 into data that can be used by controller 402. Although not shown in FIG. 4, in one embodiment, cellular transmitter/receiver 410, Wi-Fi transmitter/receiver 412, and ZigBee transmitter/receiver 414 communicate with controller 402 via middleware 404 which provides transmission error protection and correction for transmissions from one or more of cellular transmitter/receiver 410, Wi-Fi transmitter/receiver 412, and ZigBee transmitter/receiver 414.

SRD CC 204 supports an interface to storage area network 110 (also referred to as the SRD Enterprise Cloud). In one embodiment, there are three wireless technologies supported by the SRD Cluster Controller which are Cell Network LTE, Wi-Fi, IEEE 802.11n, and ZigBee IEEE 802.15.4. SRD CC 204 can use either the Wi-Fi or Cell Network LTE to connect to the storage area network 110 environment. When using the Wi-Fi option, SRD CC 204 will connect to a local Wi-Fi Access Point to further facilitate to the SRD Enterprise Cloud connection. The choice of using the Wi-Fi or Cell Network LTE to connect to the SRD Enterprise Cloud will be a function of use case and implementation. These two connection options, Wi-Fi or Cell Network LTE, will provide automatic fail over, as one connection is used as the primary and the other as secondary (backup), and are configurable.

The ZigBee IEEE 802.15.4 connection is used to support a mesh-network of nodes that are physically part of each display strip (e.g., display 304 of FIG. 3). Each display strip will have at least one ZigBee IEEE 802.15.4 end node which is integrated with a Bluetooth Low Energy (BLE) module. This ZigBee IEEE 802.15.4 end node with the integrated BLE module is referred to as iBeacon puck 310. The iBeacon puck uses the ZigBee connection to receive reprogramming instructions for the iBeacon broadcast messages.

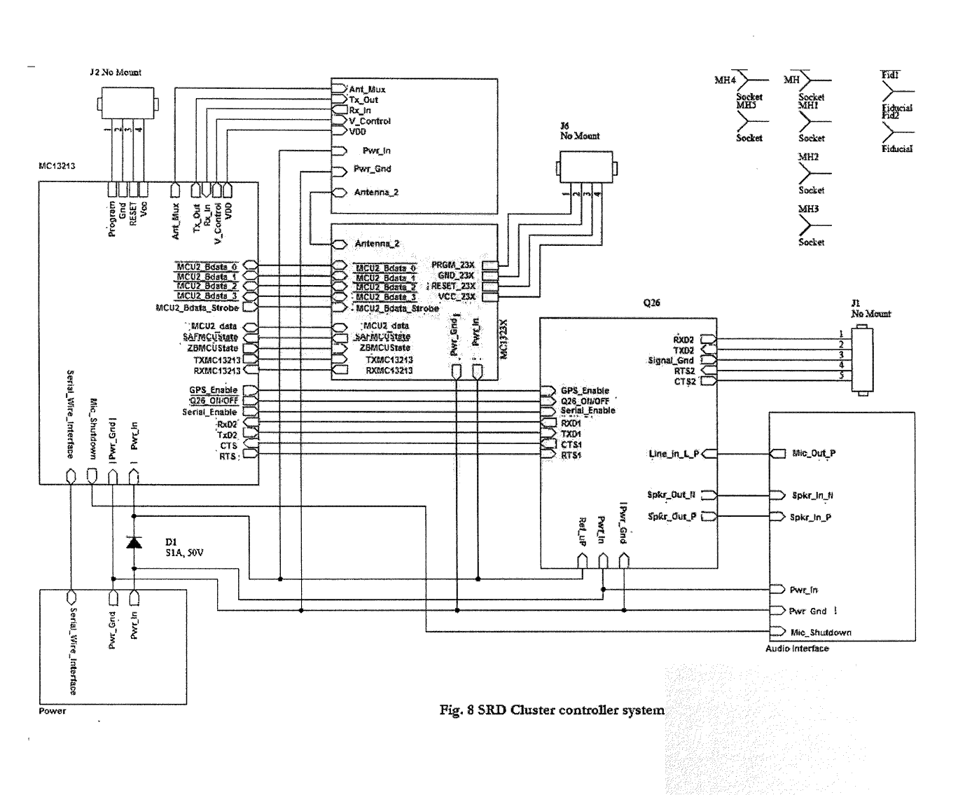

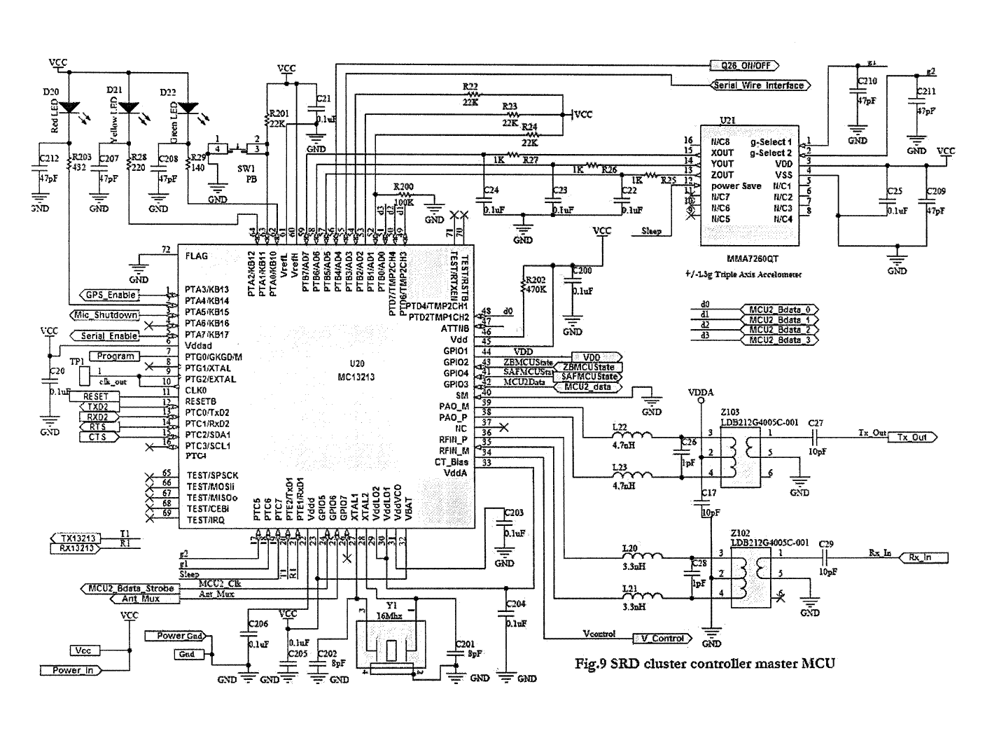

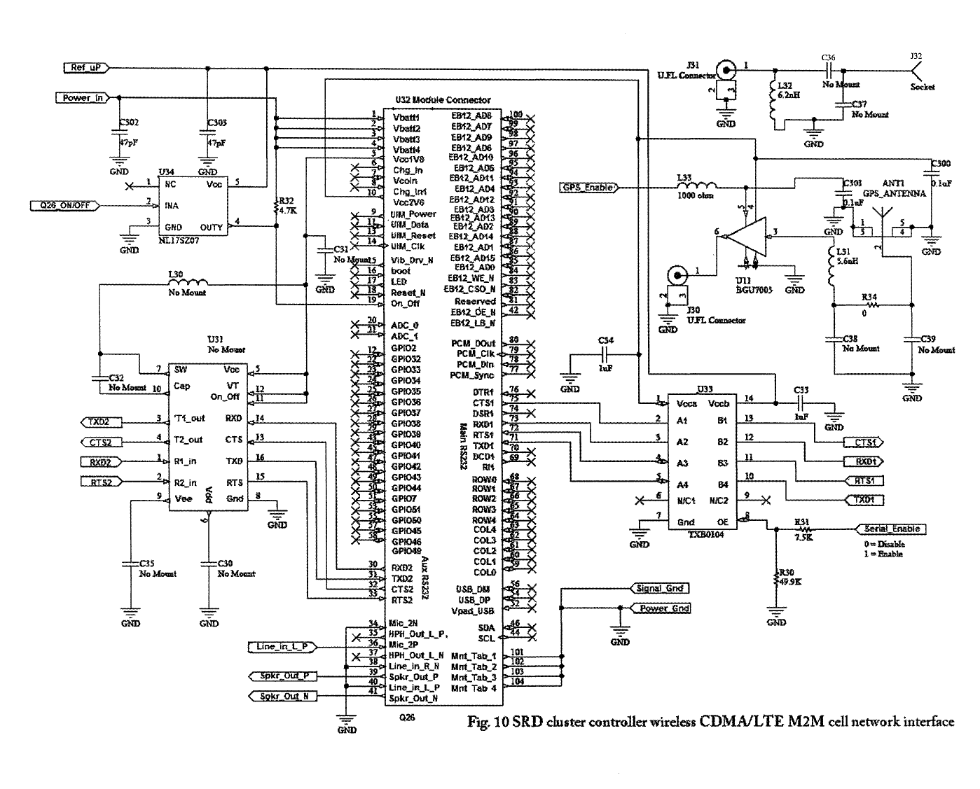

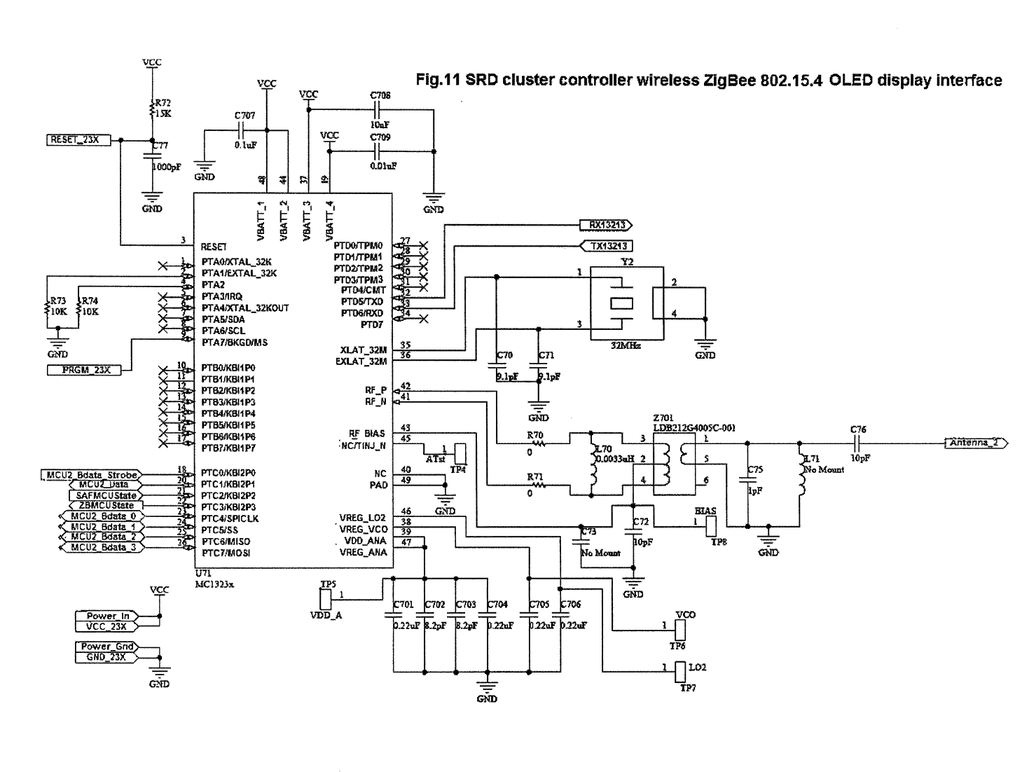

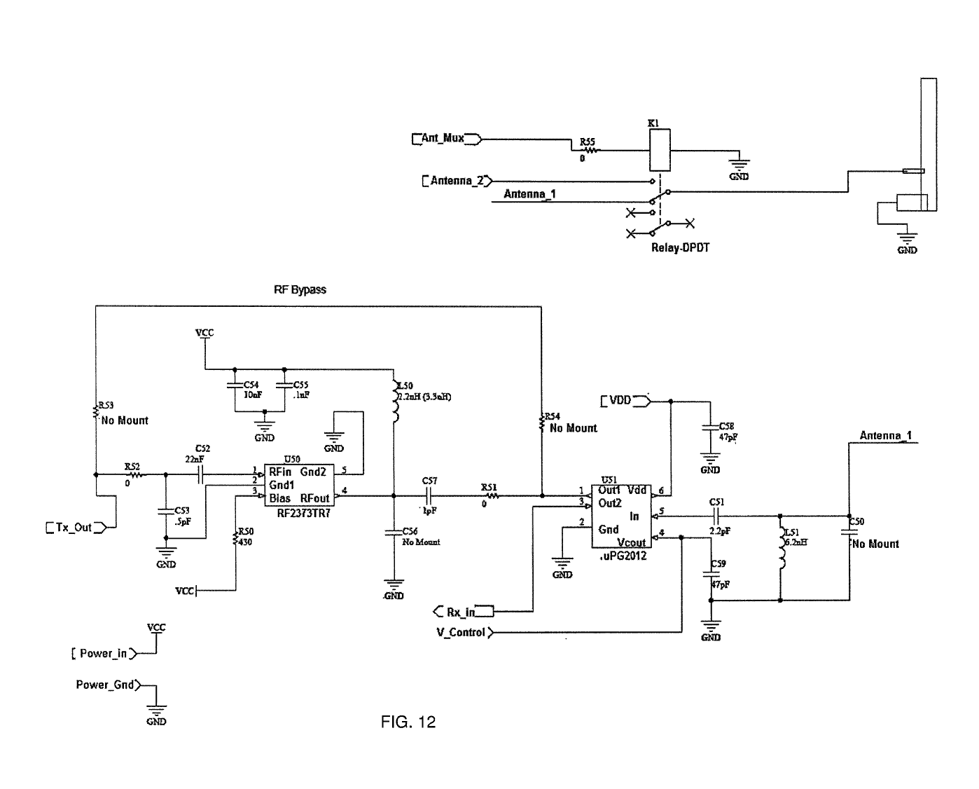

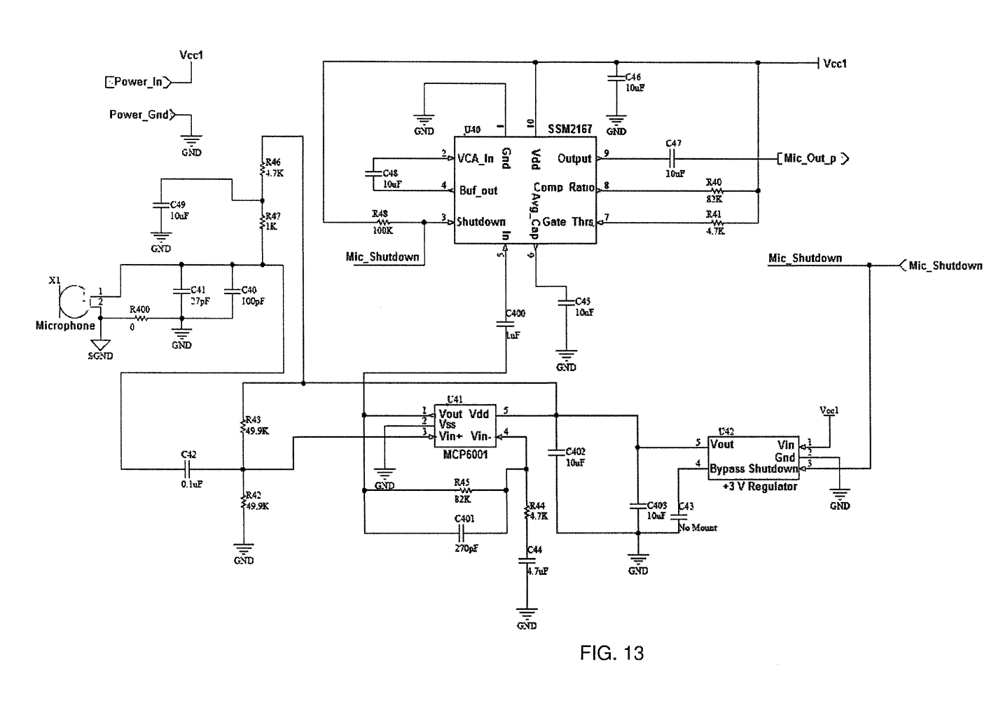

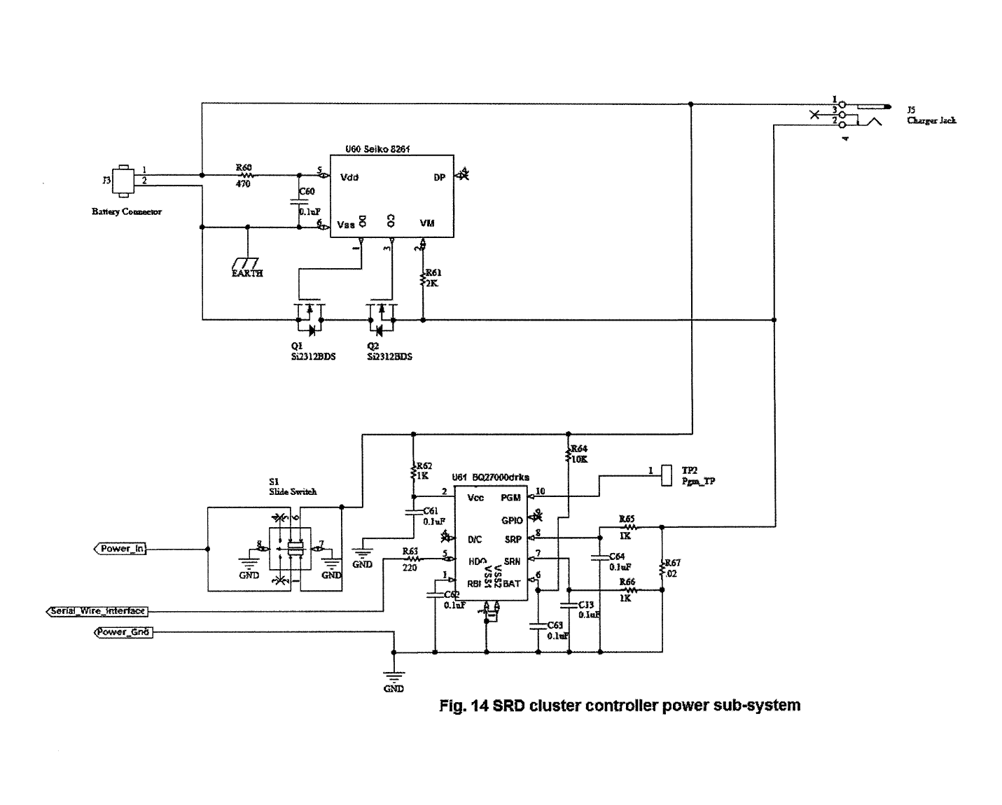

FIGS. 8 through 14 depict component level schematics of SRDCC 204 and various components contained therein. FIG. 8 depicts a component level schematic of SRDCC system according to one embodiment. FIG. 9 depicts a component level schematic of an SRD CC controller (controller 402 of FIG. 4). FIG. 10 depicts a component level schematic of a wireless CDMA/LTE M2M cell network interface (cellular transmitter/receiver 410 of FIG. 4). FIG. 11 depicts a component level schematic of a wireless network interface (wireless transmitter/receiver 412 of FIG. 4). FIG. 12 depicts component level schematic of an antenna front end for SRDCC 204. FIG. 13 depicts an acoustic sensing subsystem of SRDCC 204. FIG. 14 depicts a component level schematic of a power subsystem of SRDCC 204.

In one embodiment, controller 402 of SRD CC 204 comprises a Freescale MC13213 MCU with an integrated IEEE 802.15.4 radio frequency (RF) transceiver and a Freescale MMA7260QT 3 dimensional accelerometer as shown in FIG. 9. The integrated IEEE 802.15.4 is a short range, low power, 2.4 GHz Industrial, Scientific, and Medical (ISM) band transceivers. The RF transceiver contains a complete packet data modem which is compliant with the IEEE 802.15.4 Standard PHY (Physical) layer.

The MCU interfaces with the RF transceiver through a 4-wire SPI port and interrupt request line. The Media Access Control (MAC), drivers, and network and application software run on the MCU. The RF transceiver includes a low noise amplifier, one mW power amplifiers (PA), onboard RF transmit and receive (T/R) switch for single port use, PLL with internal voltage controlled oscillator (VCO), on-board power supply regulation and full spread-spectrum encoding and decoding. The device uses 250 kbps Offset-Quadrature Phase Shift Keying (O-QPSK) data in 2.0 MHz channels with 5.0 MHz channel spacing in accordance to the 802.15.4 Standard. The SPI port and interrupt request output are used for receive (RX) and transmit (TX) data transfer and control.

In the receive signal path, the RF input is converted to low IF In-phase and Quadrature (I & Q) signals through two down-conversion stages. A Clear Channel Assessment (CCA) is performed based upon the base-band energy integrated over a specific time interval. The digital back-end performs Differential Chip Detection (DCD), the correlator “de-spreads” the Direct Sequence Spread Spectrum (DSSS) Offset QPSK (O-QPSK) signal, determines the symbols and packets, and detects the data.

The preamble, SFD, and FLI are parsed and used to detect the payload data and FCS which are stored in RAM. A two-byte FCS is calculated on the received data and compared to the FCS value appended to the transmitted data, which generates a Cyclical Redundancy Check (CRC) result. Link Quality is measured over a 64 microsecond period after the packet preamble and stored in RAM. The RF transceiver uses a packet mode where the data is processed as an entire packet and stored in Rx Packet RAM. The MCU is notified that an entire packet has been received via an interrupt.

The RF transceiver has a data transfer mode called Packet Mode where data is buffered in on-chip Packet RAMs. There is a TX Packet RAM and an RX Packet RAM, each of which are 64 locations by 16 bits wide. Payloads of up to 125 bytes are supported. The RF transceiver adds a four-byte preamble, a one-byte Start of Frame Delimiter (SFD), and a one-byte Frame Length Indicator (FLI) before the data. A Frame Check Sequence (FCS) is calculated and appended to the end of the data

In one embodiment, cellular transmitter/receiver 410 of SRD CC 204 of FIG. 4 is implemented using a cell network controller depicted in the component level schematic of FIG. 10. The Cell Network Controller consists of a cell modem supporting a mobile equipment identifier (MEID) which is a globally unique number identifying a physical piece of CDMA mobile station equipment. An MEID is 56 bits long (14 hex digits). It consists of three fields, including an 8-bit regional code (RR), a 24-bit manufacturer code, and a 24-bit manufacturer-assigned serial number. The Cell Network Controller will have the cell modem activate a preferred roaming list (PRL) to establish a TCP communications channel with SRD Enterprise cloud environment. The PRL is a collection of frequencies that the call processing software in the Cell Network Controller uses to search for approved and unapproved CDMA networks. The PRL is loaded into the Cell Network Controller and is saved in non volatile memory (NVM).

Over the air (OTA) provisioning is used by the Cell Network Controller which a mechanism that enables the service providers to program mobile equipment. This is required in order to allow the SRD Cluster Controller to use a cell network in machine to machine mode (M2M). OTA will not write the update information until all desired data has been downloaded to the Cell Network Controller. This prevents incomplete or inconsistent data from being written when the connection is prematurely terminated and OTA did not complete all the programming.

The Cell Network Controller supports TIA/EIA/IS-683-A: Over-the-Air Service Provisioning of Mobile Stations in Spread Spectrum Systems. 683 references two variants: OTA Service Provisioning (OTASP) and OTA Parameter Administration (OTAPA). Initial provisioning of the Cell Network Controller can be achieved via OTASP. OTASP is initiated from the ME. OTAPA is used to apply updates to a Cell Network Controller that is already provisioned. OTAPA is initiated from the service provider.

Using the PRL and MRU, the Cell Network Controller has all the information necessary to look for service. The Cell Network Controller will attempt to scan to the most preferred service available where most preferred is defined by the system table in the PRL. The PRL is the primary mechanism used to determine where the module should look and lock onto service.

Service providers create PRLs and provide PRLs to the Cell Network Controller. A PRL consists of two tables; an acquisition table and a system table. The acquisition table is a list of bands and channels used to define the order of scanning channels. The system table is used to determine if the service found on a particular channel is of the optimal choice or if scanning should continue looking for better or more preferred service.

The Cell Network Controller will lock (camp) when it find suitable service, then proceed to register on the network. Service providers try to ensure the base station the Cell Network Controller camps on is their own; however roaming capabilities may result in the Cell Network Controller camping on another service provider's base station.

When the Cell Network Controller has found service, it will register according to the registration information sent from the network. Registration is the mechanism used to ensure the base station is aware of the Cell Network Controller presence, and its location relative to base station tower.

When the Cell Network Controller acquires service for the first time (either due to not having service or powering on), the Cell Network Controller will wait for 20 seconds before registering according to the IS-2000 standard. After the Cell Network Controller registers, incoming pages will be sent by the network.

The Cell Network Controller will occasionally re-register with the network. The duration between re-registration is defined by the system parameters provided on the digital control channel. The re-registration is called timer based registration. The purpose of timer based registration is to inform the network that the Cell Network Controller is still available for pages.

When the Cell Network Controller has established its connection with the service provider's cell network, it is ready to create a TCP connection with the SRD Enterprise Cloud. The Cell Network Controller uses a +WIPCREATE command to create a TCP client. Several messaging constructs are supported by the SRD middleware running on the Cell Network Controller. They are SRD_Connect, SRD_Send, SRD_Receive, SRD_Status, SRD_Confirm, and SRD_Disconnect. These messaging constructs are transactional in that they are explicitly confirmed.

In one embodiment, the Cell Network Controller consists of a Telit 910E CDMA communications module with various connection interfaces to the controlling MCU which is a Freescale MC13213 SoC processor. The combination of the Telit 910E CDMA module and the Freescale MC13213 SoC processor represent the Cell Network Controller.

The Freescale MC13213 SoC runs the SRD middleware software required to communicate to the SRD Enterprise Cloud environment. The Cell Network Controller transmits SRD event data and SRD control data via multiple TCP communication sessions either in client or server or both modes. SRD control data will be iBeacon broadcast management changes, SRD display strip content management, SRD ZigBee mesh network management changes, and SRD power management changes. SRD event data are shopper context triggers and SRD system alerts.

Wi-Fi transmitter/receiver 412 (also referred to as a Wi-Fi controller) of SRDCC 204 of FIG. 4 in one embodiment is implemented as shown in FIG. 11. The Wi-Fi Controller consists of an integrated IEEE 802.11b/g/n WLAN chip, which contains a MAC, base-band, security and radio functions in a single module. This Gainspan GS1500M module contains a GS1011 Chip ultra-low power Wi-Fi system-on-chip (SOC) which contains two ARM7-based processors. One dedicated to Wi-Fi networking services, and the other dedicated to Wi-Fi wireless services.

The MCU Master Controller will search for a saved configuration file during the initialization process. The configuration file include the auto connection settings, default profile and profile settings. If a saved configuration file is available, it is loaded from non-volatile memory. If no saved configuration file exists, the default settings will be applied. If auto connection is enabled, the Wi-Fi Controller will attempt to associate with the specified network, previously set. Once the Wi-Fi Controller is associated, it will establish a TCP connection within the specified parameters. If successful, the Wi-Fi Controller will enter command mode and any data received from the MCU Master Controller port will transmitted to the SRD Enterprise Cloud and vice versa.

The MCU Master Controller creates a TCP client via the Wi-Fi Controller that connects to the SRD Enterprise Cloud. In TCP client mode, the connection is considered established only when the Wi-Fi Controller TCP client successfully connects to the SRD Enterprise Cloud specified by the MCU Master Controller's Wi-Fi Controller configuration parameters. The Wi-Fi Controller address may be fixed or obtained from a DHCP server. The Wi-Fi Controller TCP client port is selected at random during creation of the TCP client.

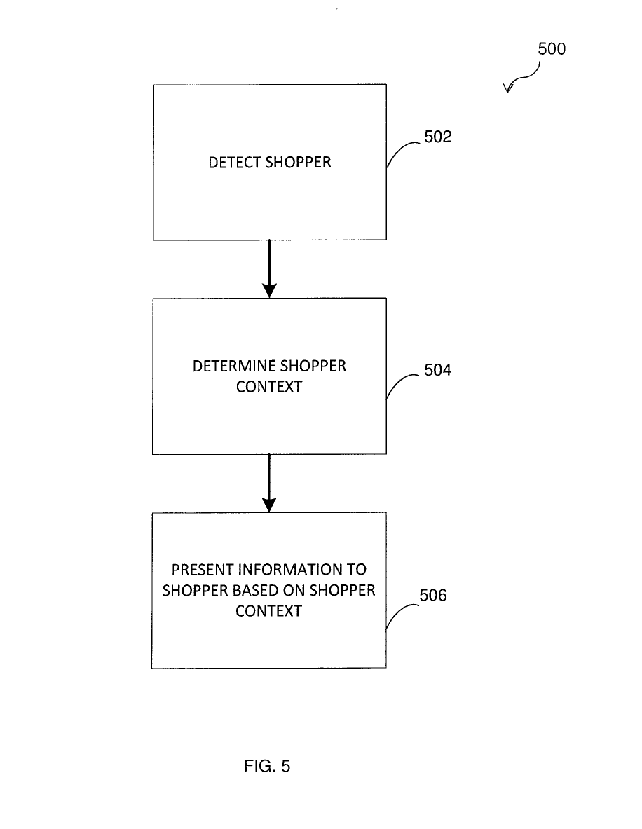

FIG. 5 depicts a flow chart of a method 500 for displaying information. Method 500 is a broad overview of the operation of system 100 of FIG. 1. Additional details are described below. At step 502, system 100 detects a shopper. Specifically, in one embodiment, an SRD, such as 102A, receives a message from a user device in response to the user device detecting a beacon transmitted by iBeacon puck 310 of SRD 102A. At step 504, shopper context is determined. Shopper context is a determination of a shopper's actions and state at a particular time or over a particular period of time and is determine using information from various components of one or more shelf screens (such as shelf screen 202A). Shopper context in one embodiment, is determined at storage area network 110 using information received from one or more SRDs such as SRD 102A. However, shopper context may be determined at a shelf screen, such as shelf screen 202A or SRD CC 204 in other embodiments. At step 506, information is presented to the shopper based on the shopper's context. For example, certain advertisements can be displayed to the user via display 304 of shelf screens 202A,202B,202C,202D based on shopper context. The method returns to step 504 and steps 504 and 506 are repeated for a particular shopper as long as the shopper is located near one or more SRDs.

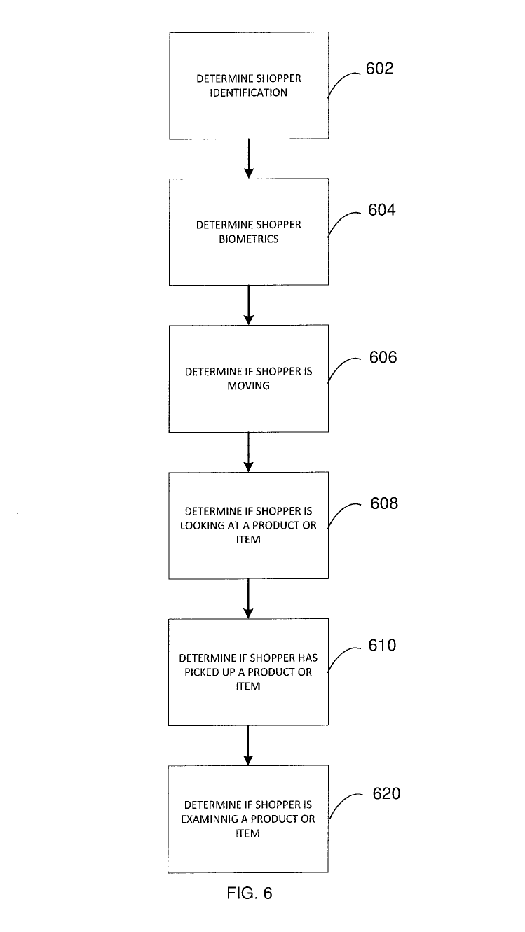

FIG. 6 depicts details of step 504 of method 500 depicted in FIG. 5. At step 602, an identification of a detected shopper is determined. At step 604, the shopper's biometrics are determined. In one embodiment, shopper biometrics include a shopper's heart rate, perspiration, blood pressure, etc. Such biometric information is obtained in one embodiment, using one or more of IR camera, sensors carried by a user, etc. In one embodiment, shopper biometrics can be obtained via sensors located on the shopper and collected by the shopper's mobile device. The shopper's biometric information can then be transmitted from the shopper's mobile device to an SRD, such as SRD 102A, SRD CC 204, or storage area network 110 via network 108 or other transmission media and/or protocol. Shopper biometrics may be used to determine a shopper's state. For example, an increase in a shopper's heart rate, perspiration, and/or blood pressure can be used to determine that a shopper is reacting to a certain stimulus, such as a product or item the shopper is looking at. At step 606, it is determined if the shopper is moving. A shopper's movement can be determine using a pair of opposing iBeacon pucks a shopper is located between, IR camera 306, and/or information from the shopper's mobile device. If is determined to be moving, information designed to catch the shopper's attention can be displayed. If a shopper is determined to not be moving, the shopper is considered to be dwelling. In response to determining that the shopper is dwelling, information can be displayed to the shopper based on the shopper dwelling at a location and the location where the shopper is dwelling. For example, if a shopper is dwelling near a specific item or product, information about the item or product can be displayed to the shopper.

At step 608, it is determined if the shopper is looking at a product or item. Where a shopper is looking is determined, in one embodiment, using IR camera 306. In response to determining that the shopper is looking at a product or item, information about that product or item, or a different product or item, can be displayed to the shopper. At step 610, it is determined if the shopper has picked up a product or item. SRD system 100, in one embodiment, detects that a shopper has picked up an item or product using information from IR camera 306 and/or shelf mat 308. At step 620, it is determined if the shopper is examining the product or item the shopper has picked up. SRD system 100, in one embodiment, determines that a shopper is examining a product or item using information from IR camera 306. Each of these shopper actions can be used to trigger specific information to be displayed to the shopper. For example, if a shopper is detected moving through an aisle, advertisements can be displayed to draw the shopper's gaze to a specific item or product. After the shopper's gaze has been drawn to the specific item or product, additional information about the product can be displayed to the shopper to entice the shopper to purchase the item. If a shopper picks up and examines the specific item or product, additional information about the item or product can be displayed to the shopper. In one embodiment, information displayed to a shopper can be based on additional information such as a shopper's prior purchase history, interests and preferences previously identified by the shopper, demographic information of a shopper, etc. Displaying various information to a shopper about specific items or products based on the shopper's actions and state can entice a shopper to purchase the particular product.

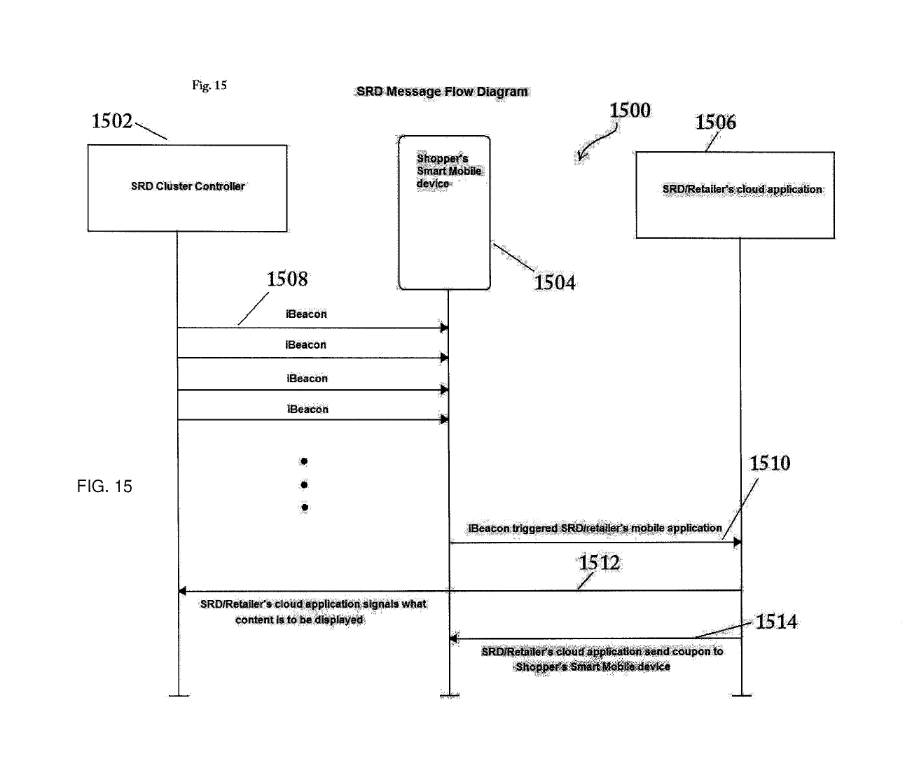

FIG. 15 depicts a SRD message flow diagram according to one embodiment which shows communications between devices (i.e., SRDCC 1502, shopper's mobile device 1504, and SRD/Retailers cloud application 1506) wherein the communications occur over time with the earliest communication (i.e., 1508) shown at the top of the flow diagram and the latest communication (i.e., 1514) shown at the bottom of the flow diagram. At step 1508, an iBeacon signal is periodically transmitted from SRD cluster controller 1502 (e.g., SRDCC 204 of FIG. 2). When shopper's mobile device 1504 (e.g., user device 104 of FIG. 1) is within range of SRD cluster controller 1502, the iBeacon triggers a mobile application on mobile device 1504 to transmit a notification to SRD/Retailers cloud application 1506 (e.g., an application on storage area network 110 of FIG. 1) as shown in step 1510. In response, SRD/Retailer's cloud application 1506 transmits content to be displayed (or an identification of content to be displayed) to SRD cluster controller 1502. In addition, at step 1514, SRDIRetailer's cloud application 1506 can also send (or push) a coupon to shopper's mobile device 1504.

Storage area network 110, in one embodiment, is a server which receives information from SRDs (e.g., SRD 102A, 102B, 102C) and transmits information to be displayed. Storage area network 110, in one embodiment, transmits specific information to be displayed to a particular shopper determined using one or more analytics and based on the shopper's actions and state. The shopper's actions and state can also be stored (e.g., archived) in a database of the storage area network for transmission to other entities for shopper activity and state analysis. Storage area network 110, in one embodiment, also receives information from checkout devices located in various retailers. Checkout information can then be used to determine sales trends and inventory. Storage area network 110 can also receive pricing information from retailers and use this information to update information displayed via the SRDs. Alternatively, shopper actions can be pushed out to a retailer's network in order to allow the retailer to analyze what products and items a shopper picked up while shopping with products and items purchased by a shopper at a checkout.

Information to be displayed via one or more SRDs, in one embodiment, is based on one or more factors. Such factors include information provided from manufacturers, information provided from retailers, information provided from third parties, and shopper identification. In one embodiment, information, such as advertisements, is provided by a manufacturer of a product. Advertisements can also be provided by retailers and third parties. The information displayed to a particular shopper can be based on the shopper's identity and whether an information provider has provided compensation for display of the information to be displayed. For example, if a particular shopper has purchased a particular brand of product in the past, a manufacturer of a competing brand may pay to have advertisements pertaining to their competing product displayed to the particular shopper. Other information, such as advertisements for products or items not available in a particular location in which a particular shopper is located (e.g., advertisements for cars) may be displayed to a user based on a manufacturer of the advertised product or item paying to have their advertisements displayed. In one embodiment, excess display space on a shelf screen (i.e., display space not associated with a product or item) can be used to display information from third parties such as automobile manufacturers, technology companies, vacation resort destinations, etc.

In one embodiment, information displayed via one or more of shelf screens 202A,202B,202C,202D includes advertisements and informational multimedia. The information displayed, in one embodiment, is configured to entice shoppers to purchase certain products and/or services. In one embodiment, other information such as warnings, lost person alerts, public service announcements, etc. can be presented to shoppers via one or more shelf screens 202A,202B,202C,202D. Information can be displayed as static images, video, a combination of static images and video, etc.

Each of shelf screens 202A,202B,202C,202D includes multiple components as described above. These components are described in further detail as follows.

Display 304 as described above, in one embodiment, is an elongated display configured to be mounted on a shelf edge of a gondola and can display standard information such as price information for products located on that particular shelf. Information displayed can be segmented based on the location of products and items on the shelf that display 304 is mounted to. For example, if four different items are placed on the shelf, sections of the display under each of the different items can display information about those items. Display 304, in one embodiment, is frameless meaning that information can be displayed along the entire length of the display with no breaks in the image. In one embodiment, display 304 is capable of being physically cut at specific intervals and the two sections will continue to function as reduced length displays. In one embodiment, the capability of cutting the display at specific intervals is supported by hardware redundancy along the original length of the display.

In one embodiment, display 304 includes touchscreen and audio output capabilities. In order to provide a shopper with the ability to always read the product information, especially when there is an advertisement being run for a particular product, display 304, in one embodiment has touch pad capabilities in order to allow the images to move from tag/pricing information to advertisement and back again. Shoppers can touch a touch screen of the display to have coupons pushed to their mobile device. In one embodiment, registration is required via an application on a shopper's mobile device or a sign up feature and retail store application download. Touch Screen capabilities also enable customers to view various items or menu of items on the screen and to further drill down to additional information regarding a product (e.g., recipes to be forwarded to mobile device, product nutritional information beyond product label, a how to video, etc.). Display 304, in one embodiment, is capable of outputting audio. Display 304 can then be used to enhance product promotion through various audible communication and sounds. Audio output can be initiated via a shopper's actions and/or state, touch screen, time delay, etc.

Infrared camera 306, in one embodiment, is a camera capable capturing an image of a shopper's body. Infrared camera 306, in one embodiment, is also capable of capturing more detailed images such as the position of the shopper's limbs and the shopper's facial expressions. In one embodiment, a visible spectrum camera can be used instead of an infrared camera. Similar to the IR camera described above, the visible spectrum camera can be capable of capturing an image of the shopper's body as well as more detailed images such as the position of the shopper's limbs and the shopper's facial expressions.

Smart mat 308, in one embodiment, is a pressure sensitive mat that can be used to determine what items and products are on a shelf on which smart mat 308 is located. Smart mat 308, in one embodiment, detects the changes in the electrical properties of continuous resistance pressure sensors, caused by the mechanical deformation of its material. The smart mat, in one embodiment, has recording durations of one second at a sampling rate of 50 Hz for a shelf pressure profile that comprises 200 elements results in 10,000 pressure data points per shelf per second. With this volume of information, in one embodiment visual presentation and data reduction techniques are used, and the graphical representation of shelf product pressure distribution is through wire frame diagrams. These shelf pressure maps are obtained for each sampling interval or at specific instants during shopper-to-product contact.

The pressure measurements, in one embodiment, are made by sensing the resistive changes in transducer material as a result of compression due to weight of a product placed on it. A variable column sense and row sense electrode grid allows for a mappable row column matrix which allows for spatial and temporal product tracking such as product removal and product additions. A 32-bit microprocessor incorporated into the smart mat enables fast row column electrode scanning at a rate of 25 to 100 complete shelf pressure profiles per second.

A shelf collection node, in one embodiment, collects shelf pressure profile data for real time 3 dimensional analysis. The shelf collection node initializes an MCU, General Purpose Input Output (GPIO), Serial Peripheral Interface (SPI), Interrupt Request (IRQ), and sets a desired RF transceiver clock frequency by calling routines including Micro Processor Unit Initialize (MCUInit), General Purpose Input Output Initialize (GPIOInit), Serial Peripheral Interface Initialize (SPIInit), Interrupt Request Initialize (IRQInit), Interrupt Request Acknowledge (IRQACK), Serial Peripheral Interface Driver Read (SPIDrvRead), and Interrupt Request Pin Enable (IRQPinEnable). MCUInit is the master initialization routine which turns off the MCU watchdog, sets the timer module to use Bus Clock (BUSCLK) as a reference with a pre-scaling of 32.

The state variable gu8RTxMode is set to SYSTEM_RESET_MODE and routines GPIO Initialize (GPIOInit), SPI Initialize (SPIInit) and IRQ Initialize (IRQInit) are called. Next, the state variable gu8RTxMode is set to RF_TRANSCEIVER_RESET_MODE and the IRQFLAG is check to see if IRQ is asserted. The RF transceiver interrupts are first cleared using SPIDrvRead and then RF transceiver is check for Antenna Interrupt (ATTN IRQ) interrupts. As a final step for MCUInit, calls are made to PLMEPhyReset (to reset the physical MAC layer), IRQACK (to Acknowledge (ACK) the pending IRQ interrupt) and IRQPinEnable (to pin Enable, IE, IRQ CLR, on signal's negative edge).

Once the shelf collector node process has been initialized is ready to receive RF packets from shelf nodes. This is started by creating an RF packet receive queue that is driven by a call back function on RF transceiver packet receive interrupts. When an RF packet is received from a shelf node, a check is first made to determine if this from a new shelf node or an existing one. If this is from an existing shelf node, RF packet sequence numbers are checked to determine continuous synchronization before further analyzing the packet. If this is a new shelf node, a shelf node context state block is created and initialized. Above this RF packet session level process for node to node communication, is the analysis of the RF packet data payload. This payload contains the compressed shelf pressure profile based on the current variable pressure analysis map. The first part of the compressed data contains a map mask array, which is structured as follows:

|0x10|00101001|00101101| * * * |00111101|00101010|245|234|219|225| * * * |233|

|start|row 1|row 2| |row 15|row m|D1|D2|D3|D4|Dn|

Where a bit in the ShelfMaskArray(row 1, row 2, . . . , row m) is set to one for data that is 255 in value. Each row representation byte uses 6 bits (upper two bits are zero and not used right now) to refer to each ND channel (there are six in the current utility). Next, the ShelfRowMask[k] array is scanned for non-active values (no compression). The location in the ShelfRowMask[k] array where to set the no compression value bit is determined. This is done by first finding out which byte of 16 (which represent rows) in the ShelfRowMask[k] array is the row that has a no compression value in it. Then remove the base value that brings in the row byte of interest and use the remainder as a bit mask and XOR with existing contents which could be other no compression values already identified.

Once the RF packet from a shelf is decompressed the collector node will use the SCITransmitArray routine to send the decompressed RF packet data gsRxPacket.pu8Data and of length gsRxPacket.u8DataLength) to the connected PC host via the USB interface. The shelf pressure data is formatted as follow:

Packet header |0x10|value of A/D CH0|value of A/D CH1|value of A/D CH2|value of A/D CH3|value of A/D CH6|value of A/D CH7|value of A/D CH0|value of A/D CH1∥value of A/D CH2|value of A/D CH3|value of A/D CH6| * * *

The IEEE 802.15.4 standard specifies a maximum packet size of 127 bytes and the Time Synchronized Mesh Protocol (TSMP) reserves 47 Bytes for operation, leaving 80 Bytes for payload. The IEEE 802.15.4 is compliant with the 2.4 GHz Industrial, Scientific, and Medical (ISM) band Radio Frequency (RF) transceiver.

The RF module, in one embodiment, contains a complete 802.15.4 Physical layer (PHY) modem designed for the IEEE 802.15.4 wireless standard which supports peer-to-peer, star, and mesh networking. It is combined with a MPU to create the required wireless RF data link and network. The IEEE 802.15.4 transceiver supports 250 kbps O-QPSK data in 5.0 MHz channels and full spread-spectrum encode and decode.

All control, reading of status, writing of data, and reading of data is done through the sensing system node device's RF transceiver interface port. The sensing system node device's MPU accesses the sensing system node device's RF transceiver through interface ‘transactions’ in which multiple bursts of byte-long data are transmitted on the interface bus. Each transaction is three or more bursts long depending on the transaction type. Transactions are always read accesses or write accesses to register addresses. The associated data for any single register access is always 16 bits in length.

Control of the shelf collector node's RF transceiver and data transfers, in one embodiment, are accomplished by means of a Serial Peripheral Interface (SPI). Although the normal SPI protocol is based on 8-bit transfers, the shelf collector node's RF transceiver imposes a higher level transaction protocol that is based on multiple 8-bit transfers per transaction. A singular SPI read or write transaction consists of an 8-bit header transfer followed by two 8-bit data transfers.

The header, in one embodiment, denotes access type and register address. The following bytes are read or write data. The SPI also supports recursive ‘data burst’ transactions in which additional data transfers can occur. The recursive mode is primarily intended for Packet RAM access and fast configuration of the shelf collector node's RF transceiver. The shelf node will wait 250 milliseconds for a response from the shelf collector node to determine whether a default full shelf electrode scan will be done or a mapped electrode scan will be initiated. In the case of a mapped electrode scan, the shelf collector node will send the appropriate electrode scan mapping configuration data.

The electrode scanning is performed by the ShelfScan routine where the ShelfDataBufferIndex is initialized and rows are activated by enabling MCU direction mode for output [PTCDD_PTCDDN=Output] and bring the associated port line low [PTCD_PTCD6=0]. As each row is activated based on the electrode scanning map, the columns which are attached to the MCU analog signal ports will sample and read the current voltage on the column lines and convert them into digital form which is the shelf product pressure across that selected row. All rows are sequentially scanned and the entire process repeats until a reset condition or inactivity power-down mode.

The shelf product pressure profile data is compressed by clearing the bit map mask array, which is structured as follows:

|0x10|00101001|00101101| * * * |00111101|00101010|245|234|219|225| * * * |233|

|start|row 1|row 2| * * * |row 15|row 16| * * * row N|Data 1|Data2|Data3| * * * |DataN|

This is where a bit in the ShelfFootMaskArray[k] is set to one for data that is no compression in value. Each row representation byte uses 6 bits (upper two bits are zero and not used right now) to refer to each A/D channel (there are six). To set the compression bit, call are made to the routine ShelfSetMask with parameters ShelfRowMaskIndex and MaskValue set accordingly, which then based on MaskValue an XOR operation is performed on ShelfRowMask[R] with a selected mask value {0x01; 0x02; 0x04; 0x08; 0x10; 0x20;}.

Several variables such as ShelfSendNumBytes and ShelfDataBufferIndex are used to prepare the IEEE 802.15.4 RF packets gsTxPacket.gau8TxDataBuffer[ ] for sending using the compressed data in ShelfDataBuffer[ ]. The RF packets are sent using the RFSendRequest(&gsTxPacket) routine. This routine checks to see if gu8RTxMode is set at IDLE_MODE and uses gsTxPacket as a pointer to call the RAMDrvWriteTx routine which then calls SPIDrvRead to read the RF transceiver's TX packet length register contents. Using these contents, mask length setting and update and then add 2 for CRC and 2 for code bytes.

A call is made to SPIDryWrite to update the TX packet length field. Next, a call to SPIClearRecieveStatReg is made to clear the status register followed by a call to SPIClearRecieveDataReg to clear the receive data register to make the SPI interface ready for reading or writing. With the SPI interface ready, a call is made to SPISendChar sending a 0xFF character which represents the 1st code byte. Next, SPIWaitTransferDone is called to verify the send is done.

SPISendChar is called again to send a 0x7E byte, which is the 2nd code byte and then the SPIWaitTransferDone is called again to verify the send is done. With these code bytes sent the rest of the packet is sent using a for loop where psTxPkt→u8DataLength+1 are the number of iterations to a series of sequential to SPISendChar, SPIWaitTransferDone, SPIClearRecieveDataReg. Once this is done, the RF transceiver is loaded with the packet to send. The ANTENNA_SWITCH is set to transmit, the LNA_ON mode enabled and finally a RTXENAssert call made to actually send the packet.

In one embodiment, using a continuous two dimensional pressure sensing grid with variable mapping capability, a three dimensional real-time shelf product pressure profile is obtained and wirelessly transmitted to a remote location for analysis and display.

iBeacon puck 310, in one embodiment, comprises a Bluetooth Low Energy (BLE) Module and a ZigBee communication module. For a capture mode for retail shopper behaviors in one embodiment, the SRD system uses iBeacon nodes as a trigger to activate and bring to the “foreground” the retailer's mobile application in the shopper's mobile device when a shopper with the smartphone with the SS iBeacon application comes into the detectable range of an iBeacon node in one of multiple shelf screens. The iBeacon is a geocoded RF signal that is for notifying mobile retail applications. Geocoding in this instance, implies a serialized unique data pattern representing a product (object) and its location without using GPS since it is indoors and GPS generally does not function.

Once the mobile SS iBeacon application detects a particular iBeacon, it will immediately establish a Wi-Fi Direct link to the particular SS Shelf the particular iBeacon is physically embedded in. The mobile SS iBeacon application will then initiate the command sequence to the SS Shelf controller via the Wi-Fi Direct link to have SS Shelf display strips present their choreographed content.

If a shopper does not have a smartphone and they are in front of iBeacon enabled SS Shelf, the SS Shelf will know this because the SS Shelf on its own has shopper presence detection and when after a few seconds there is no iBeacon initiated mobile SS iBeacon Wi-Fi Direct link, SS Shelf controllers will on their own have SS Shelf display strips present their choreographed content.

iBeacon technology leverages Bluetooth Low Energy (BLE) technology. An iBeacon device can be used to establish a detection region around an object. This allows a smartphone or any BLE enabled device with the appropriate BLE application to determine when it has entered or left the detection region, along with an estimation of proximity to the iBeacon device.

An iBeacon advertisement (also referred to as a beacon or beacon signal) provides the following information via Bluetooth Low Energy:

Universal Unique Identifier (UUID, 16 bytes) which is specific to an application and deployment use case.

Major (2 bytes) which specifies a specific iBeacon use case, such as defining a detection sub-region within a larger detection region or use case.

Minor (2 bytes) which allows further subdivision of detection region or use case.

The UUID, major and minor values provide the identifying information for the iBeacon. This specific information is hierarchical in nature with the major and minor fields allowing for subdivision of the identity established by the UUID. A specific example is a retailer where the UUID is shared by all retailer locations. This allows a smartphone to use a single identifier to recognize any of the stores with a single detection region. Each specific store is assigned a unique major value, allowing a smartphone to identify which specific store it is in. Within each individual store, departments are given separate minor values, although these are the same across stores to make it easier for an app on a smartphone to readily identify departments.

Using this information, a smartphone can identify when it has entered or left one of the stores, which specific store it is, and what department the shopper with the smartphone might be standing in. These values are determined by the retailer deploying the iBeacon devices. iBeacon enables flexibility by defining detection regions with an identifier. This allows iBeacons to be affixed to objects that are not tied to a single location.

iBeacon devices can be used to set a detection region around a movable object like a food truck or on a cruise ship. The same identifier can be used by multiple devices. This would enable a retailer to use beacons in all their locations and allow a smartphone to know when it enters any one of them.

With signals are received from a device with iBeacon technology, the signal strength is generally correlated to how far away a smartphone is from the iBeacon. In an ideal condition which is an unobstructed line of sight between a smartphone's antenna and the iBeacon the more accurate the result. When a smartphone is far away from an iBeacon, the signal strength will be lower than when it is closer.

As the smartphone gets closer to the iBeacon, the received signal strength increases. Signal attenuation, or the loss of intensity of a signal, can be caused by many factors. Physical materials surrounding the iBeacon, such as the wall between the smartphone and the iBeacon will affect the received signal strength. This will cause the smartphone to believe the iBeacon is further way than it physically is.

The human body is an attenuator of BLE signals. So when a human body is between an iBeacon and the smartphone this will affect the signal strength and will lower the accuracy. An application can request notifications when a smartphone enters or leaves a detection region defined by a beacon. When an application makes this request to begin monitoring an iBeacon detection region it must specify the UUID of the iBeacon advertisement. By using a single UUID in multiple locations, a smartphone can monitor many physical locations simultaneously. Using the retail store scenario, a smartphone can monitor 3 separate physical locations using the same UUID.

In addition to the UUID, an application can optionally supply the major and minor fields to further specify an IBeacon region to be monitored. If the app only specifies a UUID for the iBeacon detection region then it will be notified when the shopper with the smartphone enters or leaves any of the retail stores. In this case, the major field is being used to determine specific retail stores, if the shopper with the smartphone only wanted to be notified when entering a specific retail store, the application could configure the iBeacon detection region using the UUID+major value.

In another case, maybe the shopper with the smartphone is only interested in being notified when they have entered a specific department in that store. In that case the application would configure the beacon using UUID+major+minor values. As with the existing iBeacon detection region monitoring, when the shopper with the smartphone enters or exits the iBeacon detection region, the application will be notified.

The ShelfScreen system once in sync with a consumer's smart phone, containing the retailer's app, will now have the ability to begin communicating with that consumer regarding their shopping experience. This will include pushing coupons to the consumer while walking past specific departments, store product availability per-determined shopping list routes (product mapping for ease of shopping experience). In this situation, a consumer goes to the retailers app, puts in their shopping list, enters store and the list is mapped item by item, aisle by aisle, shelf by shelf until the list is completed.

Projector 312, in one embodiment, is capable of projecting a two dimensional image onto a surface. In one embodiment, projector 312 is capable of generating holograms. As such, the SRD System has the capability to project information both as a hologram in space in front of particular product/products, onto the floor in front of a product/products, or into the air above the isle. The SRD system, being completely wireless has the capability of displaying these images, in all stores, a region, or even an individual location and can be altered or replaced completely with other information without disrupting store personnel, adding costs associated with printed materials, while grabbing consumer attention and drawing them to the product for instant purchase intent.

In one embodiment, projector 312 is implemented using a digital light processing (DLP) engine that presents information based on real-time shopper actions. These actions can be just simple pass by of products on SS or complex shopper gestures or product handling as described above in connection with FIG. 6. In one embodiment, an analytic process that is rules based will make the determination of what content to display via the DLP engine.

Barcode scanner 314, as described above in one embodiment, is a scanner for detecting barcodes on items. In one embodiment, barcode scanner 314 is an optical laser type scanner for reading barcodes but can also be visible light optical image detector. Barcode scanner 314, in conjunction with barcode scanners on other shelf screens located nearby provides the ability to read bar codes from any angle so long as the barcode is not physically obstructed.

SRD system 100 can be used for other functions as well as the dynamic display of information. Some of these functions are described as follows.

In one embodiment, SRD system 100 can be used for inventory control. In one embodiment, SRD system 100 using various components, such as IR cameras and smart mats, can detect products visually and physically (e.g., by weight). As such SRD system 100 can detect when products or items are added to or removed from a shelf. In one embodiment, inventory is counted when received in case allotments when delivered to the particular store. The product then will be added into a database of the SRD system when placed on the shelf and then removed from the on-shelf inventory when picked up and removed by the customer. In one embodiment, this can trigger the need to have additional product placed back onto the shelf for display and sales purposes. The product can be completely removed from the store's inventory system once scanned at the check out position. The Infrared sensing device, in one embodiment, is capable of determining actual package graphics and brand names, depending on the size of the product itself.

In inventory control embodiments, the SRD system can complement any current inventory system already in place within a particular retail account, or can be used as a stand-a-lone inventory system for new customers or those looking for a more comprehensive inventory control and shelf-stocking program.

In one embodiment the SRD system can act as a security system. The SRD system is equipped with motion sensor technology, which is primarily used as a power saving device and automatically lights up the shelf when motion is detected. This system can also be used as a back-up security system, when the store is closed for any period of time using this same technology. While there is no motion in the store, the shelves go on stand by mode and power down. As soon as there is any kind of slight motion (these sensors can be configured to be extremely sensitive) the screens are powered back up instantly and this can trigger an alarm if the store has been closed.

The security aspect of the system detects the changes in the electrical properties of continuous resistance pressure sensors, caused by the mechanical deformation of its material as a result of product removal. The security aspect of system has a sampling rate of 10 Hz for a shelf pressure profile that comprises 200 elements results in 2,000 pressure data points per shelf per second. A variation in the real-time captured pressure profile will generate an alert. These alerts are controller by a rules based process for alarm escalation.

Sensor fusion results from combining the outputs from multiple sensors capturing a common event, such that the fused result better captures the event than any single constituent sensor inputs. Its primary objective is to tease out a clean signal, an event or a motion, from the noise generated by these multiple sensors, a mobile device, and an environment in which the sensors and mobile device are located.

Context awareness involves another layer of algorithms that interpret multiple sensor data to infer higher level information. These algorithms distill a context, for example: the retail user is examining product into a series of characteristic features in multiple sensor data. The presence of these and other features in captured sensor data inform the context detection algorithm if the examining context is valid. People will examine products differently; robust context detection must be abstracted over a representative population of retail users. Sensor fusion, along with embedded processing and connectivity, enables context awareness, and context awareness enables a new world of services. Information is presented to a shopper based on the shopper's context. A shopper's context is determined based on the shopper's actions and/or state. A shopper's actions and/or state can also be referred to as a shopper's texture.

Context is defined as the circumstances or facts that form the setting for an event, statement, situation or idea. In software programming, context-aware apps examine who, where, when and what, and the software designer uses this contextual information to determine why a situation is happening and then encodes some action in the application.

Based on this definition, the four most important categories of information to formulate a context-aware action are identity, location, time, and activity. In using contextual information to formulate a deterministic action, context interfaces occur within (and in between) first a human being, then the environment and, lastly, machine and infrastructure elements. The same way that a canvas, a collection of paint tubes and a brush allow an artist to create a masterpiece, context awareness and these interfaces are the tools for enabling a variety of services that otherwise would not be meaningful. This is where incremental improvements in technology can lead to the whole being much greater than the sum of its parts. Sensor can detect and provide information concerning a human beings' emotions. Sensors provide access to the human mindset, making an experience more “personal.”

Through the use of the infrared capabilities of SRD system 100, the system can capture shopper texture during the normal shopping experience. This includes the collection of big data, which can be captured, compiled and sold to manufactures much like scan track and IR data is sold today. Through the use of Sensor Fusion, not only can SRD system 100 capture consumer patterns such as stopping to view a product, picking up a product, putting it back or placing the item in a shopping cart, but we can also view facial expressions, such as frowning, smiling, etc. without actually seeing who the particular person is in order to protect their privacy. This real-time data capturing will also allow interaction with the consumer through a number of reactionary devices (e.g., push/pull devices).

SRD system 100 captures real-time retail shopper actions (shopping textures) while concurrently displaying dynamic shopper context-based multimedia content. A context is defined as the circumstances or facts that form the setting for an event, statement, situation or idea. Context-aware systems examine where, when, and what that then becomes contextual information which is used to determine why a situation is happening and then encodes some action in the context-aware system. To identify a context-aware action the context-aware system needs to confirm a shopper (human entity), their location, the time of shopper recognition, and shopper activity.

The interactions and interfaces between the shopper, the SRD system 100, shopping environment and SRD system 100 infrastructure provide real-time data points for determining context awareness, including: motion, posture, strides, reaction to visual stimuli. After input data is collected by the sensing nodes, an embedded node processes the context-aware data and either provides immediate action or passes it on to the cloud which is an elastic network-based processing.

The SRD shopper texture analytics use a decision tree (binary tree) where each non-leaf node has two sub-nodes. The implementation is used for both classification and regression analysis. For classification, each tree leaf is marked with a class label and where multiple leaves may have the same label. For regression, a constant is assigned to each tree leaf, so the approximation function is piecewise constant.

In predicting which requires reaching a leaf node and obtaining a response for the input a shopper to product interaction feature vector (shopping texture), the prediction routine starts with the root-node. From each non-leaf node the routine goes to the left selecting the left sub-node as the next observed node or to the right based on the value of a certain variable whose index is stored in the observed node.

There are two types of variables: ordered variables and categorical variables. An ordered variable is a value that is compared with a threshold that is also stored in the node. If the value is less than the threshold, the routine goes to the left and if greater, it goes to the right.

A categorical variable is a discrete value that is tested to see whether it belongs to a certain subset of values from a limited set of values the variable can take and this stored in the node. If the categorical variable belongs to the limited set of values, the routine goes to the left and if not, it goes to the right.

In each node, a pair of entities (variable_index, decision_rule (threshold/subset)) is used. This pair is called a split which is a split on the variable variable_index. Once a leaf node is reached, the value assigned to this node is used as the output of the prediction routine.

The tree is built recursively, starting from the root node. All training data which are feature vectors and responses are used to split the root node. In each node the optimum decision rule on the best primary split is found based on gini “purity” criteria for classification and sum of squared errors for regression.

When the tree is built, it may be pruned using a cross-validation routine. To avoid model over-fitting, some of the branches of the tree are cut off. This routine is usually only applied to standalone decision trees. Typically, tree ensembles build trees that are small enough and use their own bounded schemes against over-fitting.

One salient property of the decision tree algorithm is an ability to compute the relative decisive power & importance of each variable. For a shopper to product interaction feature vector (shopping texture), the variable importance rating is used to determine the most frequent interaction type such as stopping and briefly staring at item helps keep the dictionary database size reasonable.

The importance of each variable is computed over all the splits on this variable in the tree, primary and surrogate ones. To compute variable importance requires the surrogate splits enabled in the training parameters, even if there is no missing data.

In one embodiment, a decision tree (also referred to as a binary tree) context-aware data algorithm allows for presenting a series of questions about specific shopper context data features that each gets an answer of yes or no. These questions are arranged in an order that allows for narrowing down on the attributes/characteristics of shopper context-aware data to be classified. These questions will be asked until it is determined which of one of two categories (classification groups) it will belong to. The questions will branch (binary split) to other questions based on yes or no answers, the other questions at the same depth in the decision tree are not test or traversed. When no further questions remaining in series of questions branch, it can be determined which of two groups the specific of shopper context-aware data feature belongs to.

The decision tree context-aware data algorithm classify by using binary decisions by reducing the amount of uncertainty with each answered question relative to the total number of questions in the entire decision tree. This allows decision tree, especially when the decision tree balanced symmetrically around the root, to be very effective classifiers.

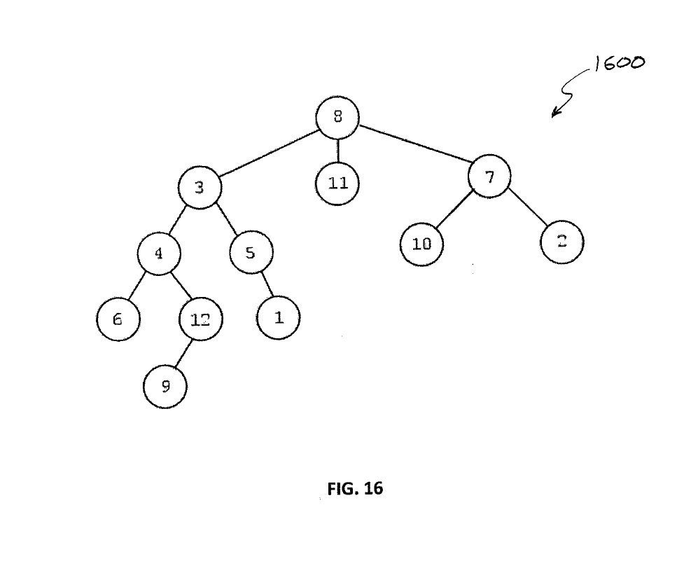

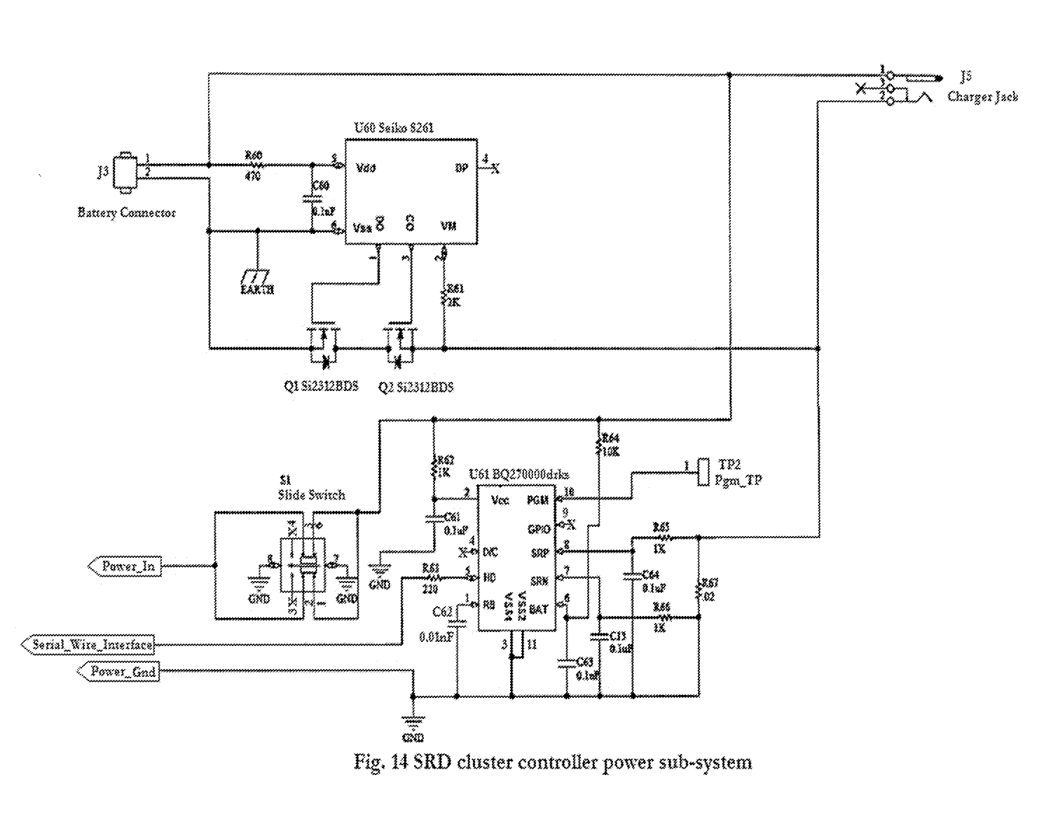

FIG. 16 depicts an example binary search tree 1600 used extensively in the decision tree (binary tree) context-aware data algorithm. Consider an example for the set S=[1, 2, 3, 4, 5, 6, 7, 8, 9, 10, 11, 12]. In order to find an element, the search starts at the root and the element is compared to the data in the current vertex which is the initially the root. If the element is greater the search is continued through the right node, if it is smaller the search is continued through the left node, if it is equal the element has been found. If the search reaches a terminal vertex without finding the element, then that element is not present in S.

A decision tree context-aware data algorithm according to one embodiment is attached hereto as Appendix A.

In one embodiment, a shopper's user device executes an application which facilitates information transfer in the SRD system. The application allows a user to enter personal information and preferences as desired which the system can then use to determine information to be displayed to the shopper. In one embodiment, the application also supports receipt of coupons transmitted (e.g., pushed) to the user device from the SRD system. The application can be specific to a particular company or business and use an SRD kernel which enables opening of the application when an iBeacon signal is detected. In one embodiment, the application is required to be authorized by a user of the user device on which the application is installed prior to operation or activation by a beacon signal.

In one embodiment, a shopper can enter their shopping list associated with a retailer into an app on their user device. The SRD system can then provide the shopper with product availability of the products and/or items on the shopper's shopping list. In one embodiment, the SRD system can provide the user with a map of a retail store and a path the shopper can follow through the store to pick up available items on the shopper's shopping list.

SRD 102A,102B,102C can each be powered in one or more ways including connecting to a power outlet. In one embodiment, each gondola is equipped with a removable power source. This allows gondolas to be placed in locations without concerns about supplying separate power to the gondola such as through the use of a power outlet. Use of a removable power source also allows for replacement of a power source with a low charge to be replaced with a power source previously charged at a remote location. An SRD may also be supplied with power from solar cells mounted on the gondola or remotely. Alternatively, solar cells may be used to augment a power supply connected to an SRD.

In one embodiment, a resource manager is implemented in SRD system 100 in order to conserve power. A resource manager identifies significant changes in sensor data that suggest a context change (i.e., a shopper's context is changing). By detecting significant changes in sensor data that suggest a context change, SRD system 100 can operate in a low power state until it is necessary to determine whether information displayed to a shopper should be changed. In addition, operations of SRD system 100 can be segmented to separate high power use operations from low power use operations so that high power use operations can be performed when needed and not continuously.

It should be noted that identification of a shopper, determining shopper biometrics, as well as any other personal information about a shopper are only determined with authorization from the shopper. In embodiments where a shopper has not authorized shopper identification, the shopper is assigned a unique identifier so that the particular shopper can be identified without determining the actual identity of the shopper. As such, in one embodiment, shoppers who have not authorized shopper identification are assigned a unique identifier that is not linked to a shopper's actual identity, such as the shopper's name, address, etc.

It should be noted that SRD system 100 has been described in a retail setting such as a grocery or retail store but other applications are possible as well. For example, SRD system 100 can be used in any setting where people are present and where a person's actions and/or state may be detected and used to modify the information presented. For example, SRD system 100 can be installed and operated at train stations, airports, subway stations, shopping malls, etc. In various installations, the size and location of displays may be different. However, the dynamic presentation of information based on a person's actions and/or state may be utilized.

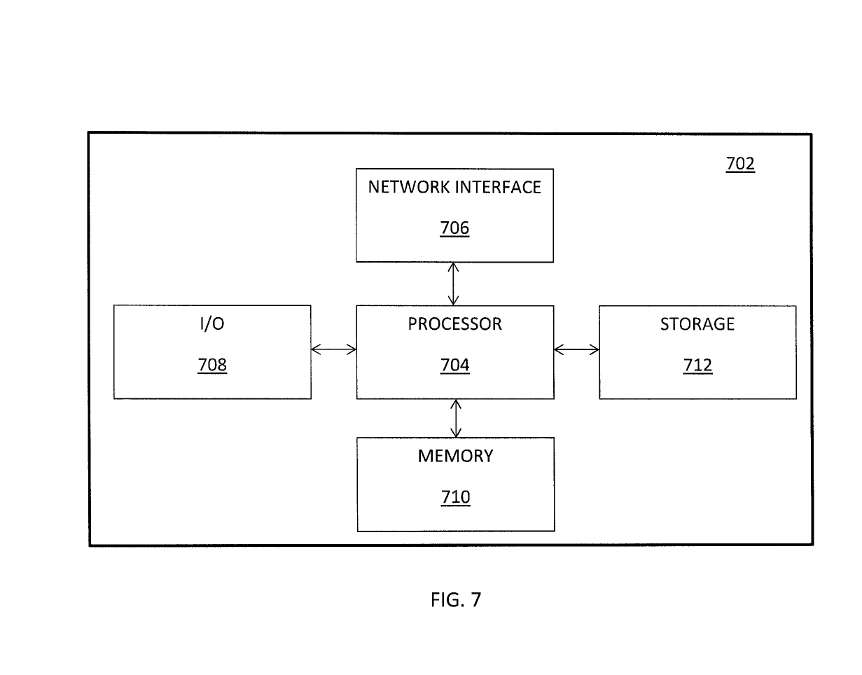

Each of the components of SRD system 100 shown in FIG. 1, in one embodiment, is implemented on a computer. A high-level block diagram of such a computer is illustrated in FIG. 7. Computer 702 contains a processor 704 which controls the overall operation of the computer 702 by executing computer program instructions which define such operation. The computer program instructions may be stored in a storage device 712, or other computer readable medium (e.g., magnetic disk, CD ROM, etc.), and loaded into memory 710 when execution of the computer program instructions is desired. Thus, the method steps of FIGS. 5 and 6 can be defined by the computer program instructions stored in the memory 710 and/or storage 712 and controlled by the processor 704 executing the computer program instructions. For example, the computer program instructions can be implemented as computer executable code programmed by one skilled in the art to perform an algorithm defined by the method steps of FIGS. 5 and 6. Accordingly, by executing the computer program instructions, the processor 704 executes an algorithm defined by the method steps of FIGS. 5 and 6. The computer 702 also includes one or more network interfaces 706 for communicating with other devices via a network. The computer 702 also includes input/output devices 708 that enable user interaction with the computer 702 (e.g., display, keyboard, mouse, speakers, buttons, etc.) One skilled in the art will recognize that an implementation of an actual computer could contain other components as well, and that FIG. 7 is a high level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method comprising:
outputting first content via an output device, the first content pertaining to an item for sale located in an area associated with the output device;
detecting a person located in the area;
determining a state of the person;
determining an action the person is performing;
determining a context of the person based on the state of the person and the action the person is performing; and
outputting second content via the output device, the second content pertaining to the item for sale and selected based on the context of the person.

2. The method of claim 1, wherein the determining the state of the person comprises:
identifying the person; and
determining a biometric of the person.

3. The method of claim 1, wherein the detecting the person comprises:
transmitting a signal from a device associated with the output device; and
receiving, by the device, a message from a user device associated with the person, the message transmitted in response to the user device receiving the signal.

4. The method of claim 1, wherein the first content is configured to draw a gaze of the person.

5. The method of claim 1, wherein the determining the state of the person comprises:
receiving data associated with the person from a plurality of sensors.

6. The method of claim 1, wherein the determining the action the person is performing comprises:
detecting that the gaze of the person is directed to the output device.

7. The method of claim 1, wherein the determining the action the person is performing comprises:
detecting that a gaze of the person is directed to the item for sale.

8. The method of claim 1, wherein the determining the action the person is performing comprises:
detecting that the person is examining the item.

9. The method of claim 8, further comprising:
outputting third content in response to the detecting that the person is examining the item,
wherein the examining the item comprises the person looking at the item, the third content pertaining to the item and selected based on the person looking at the item.

10. The method of claim 8, further comprising:
outputting third content in response to the detecting that the person is examining the item,
wherein the examining the item comprises the person picking up the item, the third content pertaining to the item and selected based on the person picking up the item.

11. The method of claim 8, further comprising:
transmitting a message pertaining to the item for sale to a user device associated with the person in response to the detecting that the person is examining the item.

12. The method of claim 1, wherein the determining an action the person is performing comprises determining that the person is dwelling.

13. The method of claim 1, wherein the determining an action the person is performing comprises determining that the person is moving through the area.

14. A method for operation of a retail shelf display comprising:
outputting first content via an output device attached to a retail shelf storing at least one item, the first content pertaining to an item on the shelf;
detecting a person located in an area associated with retail shelf via a sensor associated with the output device;
determining a state of the person;
determining an action the person is performing;
determining a context of the person with respect to the item, the context based on the state of the person and the action the person is performing; and
outputting second content via the output device, the second content pertaining to the item for sale and selected based on the context of the person.

15. The method of claim 14, wherein the determining the state of the person comprises:
identifying the person; and
determining a biometric of the person.

16. The method of claim 14, wherein the detecting the person comprises:
transmitting a signal from a device associated with the output device; and
receiving, by the device, a message from a user device associated with the person, the message transmitted in response to the user device receiving the signal.

17. The method of claim 14, wherein the determining the state of the person comprises:
receiving data associated with the person from a plurality of sensors.

18. The method of claim 14, wherein the determining the action the person is performing comprises:
detecting that a gaze of the person is directed to the item on the shelf.

19. The method of claim 18, further comprising:
detecting that the person is examining the item on the shelf; and
outputting third content in response to the detecting that the person is examining the item on the shelf,
wherein the examining the item comprises the person looking at the item, the third content pertaining to the item and selected based on the person looking at the item.

20. A computer readable medium storing computer program instructions, which, when executed on a processor, cause the processor to perform operations comprising:
outputting first content via an output device, the first content pertaining to an item for sale located in an area associated with the output device;
detecting a person located in the area;
determining a state of the person;
determining an action the person is performing;
determining a context of the person based on the state of the person and the action the person is performing; and
outputting second content via the output device, the second content pertaining to the item for sale and selected based on the context of the person.
